(19) United States
(12) Patent Application Publication
(10) Pub. No.: US 2025/0154710 A1
(43) Pub. Date: May 15, 2025

(54) Lifter As Pet Hair Filter

(71) Applicant: WHIRLPOOL CORPORATION, Benton Harbor, MI (US)

(72) Inventors: Vinayak A. Afajalpurkar, Pune (IN); Akshat Jain, Pune (IN); Gurjeet Singh Virdi, Pune (IN); Jalindar S. Dawange, Nashik (IN); Massimo Battaglia, Novara (IT); Ravindra B. Salunkhe, Satana (IN); Venkatesh G. Ajari, Gadhinglaj (IN); Kiran Nakil, Latur (IN)

(21) Appl. No.: 18/940,285

(22) Filed: Nov. 7, 2024

Related U.S. Application Data
(60) Provisional application No. 63/597,406, filed on Nov. 9, 2023.

(51) Int. Cl. D06F 39/10; B01D 29/05; B01D 29/64; B01D 35/30; D06F 23/02; D06F 37/06; D06F 58/04

(52) U.S. Cl. CPC D06F 39/10; B01D 29/05; B01D 29/6484; B01D 35/30; D06F 23/02; D06F 37/06; D06F 58/04; B01D 2201/305; B01D 2201/4084

(57) ABSTRACT

Removable filter apparatus for a laundry treating appliance are provided. A filter element is selectively attachable to a lifter base, the filter element being sized to fit within the lifter cover to allow an array of bristles extending upward from the filter element to capture particulate within the water flow. A cleaning comb is hingedly attached to the lifter cover, operable to be rotatably lifted through the filter element to remove pet hair from the bristles of the filter element. A chamber wall extends from an apex of the generally trapezoidal prism shape of the lifter cover downwards towards the open rectangular bottom, the chamber wall dividing the processing space into two water flow paths. Pouch filter elements are selectively attachable to the lifter cover for placement within the two water flow paths to allow the pouch filter elements to capture particulate within the water flow.

### CROSS-REFERENCE TO RELATED APPLICATIONS

This application claims the benefit of U.S. provisional application Ser. No. 63/597,406, filed Nov. 9, 2023, the disclosure of which is hereby incorporated in its entirety by reference herein.

### TECHNICAL FIELD

The present disclosure generally relates to laundry appliances, and more specifically, to laundry appliances that include lifters disposed within a rotating drum, where the lifters include a removable filtering mechanism for separating particulate matter from loads of laundry being processed within the drum.

### BACKGROUND

Laundry treating appliances, such as clothes washers, clothes dryers, and refreshers, may have a rotating drum that defines a treating chamber in which laundry items are placed for treatment. The drum may be disposed within the interior of a cabinet between opposing front rear bulkheads.

### SUMMARY

In one or more illustrative examples, a removable filter apparatus for a laundry treating appliance includes a lifter cover, defining a generally rectangular prism shape with an open rectangular bottom, the lifter cover being slidably attachable along the open rectangular bottom to a lifter base of an inner circumferential surface of a drum of the laundry treating appliance, the lifter cover defining through openings to allow for free flow of water therethrough; a filter element defining a rectangular body sized to fit within the lifter cover and including bristles extending from the rectangular body into the water flow to capture particulate within the water flow, the filter element being selectively attachable to the lifter base; and a cleaning comb hingedly attached to the lifter cover by a snap-on hinge assembly, operable to be selectively rotatably lifted through the filter element to clean the bristles of the filter element.

In one or more illustrative examples, the lifter base defines a plurality of engaging hooks, and the lifter cover defines a corresponding plurality of internal projections along its length, the engaging hooks being sized and positioned to receive respective ones of the internal projections of the lifter cover when the lifter cover is slid onto the lifter base.

In one or more illustrative examples, the lifter base further defines guide rails extending outward along at least a portion of the length of the lifter base, allowing the projections to slide along the guide rails into the engaging hooks, thereby securing the lifter cover to the lifter base.

In one or more illustrative examples, the lifter cover defines a lock opening through the lifter cover, sized to receive a snap button of the lifter base, the snap button being supported by a flexible leg extending upwards from the lifter base, such that as the lifter cover is slid onto the lifter base, the snap button rides an inner surface of the lifter cover, causing the flexible leg to bend downwards until the snap button reaches the lock opening to latch into place into the lock opening.

In one or more illustrative examples, the snap button is pressable to free the snap button from the lock opening, allowing the lifter cover to be slid off the lifter base.

In one or more illustrative examples, the filter element defines through holes to retain the filter element to latching posts extending upwards from an upper surface of the lifter base.

In one or more illustrative examples, the bristles are arranged into an array of spaced apart rows and columns of bristle elements.

In one or more illustrative examples, the lifter cover is contoured to vary in height with respect to the lifter base, and the bristles correspondingly vary in height to follow the contour of the inner surface of the lifter cover.

In one or more illustrative examples, the cleaning comb comprises a generally flat rectangular base defining an array of pass throughs corresponding to the bristles as arranged, allowing the cleaning comb to fit between the rows and columns of the array of bristles of the filter element.

In one or more illustrative examples, the cleaning comb defines an end pivotably attached to a corresponding end of the filter element by the snap-on hinge assembly such that the cleaning comb is rotatably positionable flat against the filter element during operation of the laundry treating appliance and pivotable through the bristles of the filter element for cleaning of the filter element.

In one or more illustrative examples, the filter element comprises a hinge snap of the snap-on hinge assembly defining a semi-circular hinge channel, and the cleaning comb defines a pivot pin of the snap-on hinge assembly, parallel to and spaced away from the rectangular body of the filter element, such that the hinge snap is attachable to the pivot pin to allow the filter element to rotate freely about the pivot pin.

In one or more illustrative examples, the lifter cover further comprises an undulating upper surface to promote water flow turbulence and improved particulate capture within the filter element.

In one or more illustrative examples, the through openings in the lifter cover are defined by longitudinal sides of the lifter cover in a spaced-apart pattern to prevent laundry articles from entering the lifter cover while allowing the free flow of water during both clockwise and counter-clockwise rotation of the drum.

In one or more illustrative examples, a laundry treating appliance having a removable filter apparatus includes a lifter base attached to an inner circumferential surface of a drum of the laundry treating appliance; a lifter cover, defining a generally rectangular prism shape with an open rectangular bottom, the lifter cover being slidably attachable along the open rectangular bottom to the lifter base, the lifter cover defining through openings to allow for passage of a water flow; a filter element defining a rectangular body sized to fit within the lifter cover and including bristles extending from the rectangular body into the water flow to capture particulate within the water flow, the filter element being selectively attachable to the lifter base; and a cleaning comb hingedly attached to the lifter cover by a snap-on hinge assembly, operable to be rotatably lifted through the filter element to clean the bristles of the filter element.

In one or more illustrative examples, the lifter base defines guide rails extending outward along at least a portion of the length of the lifter base and a plurality of engaging hooks, and the lifter cover defines a corresponding plurality of internal projections along its length, the engaging hooks being sized and positioned to receive respective ones of the internal projections of the lifter cover, allowing the projections to slide along the guide rails into the engaging hooks, thereby securing the lifter cover to the lifter base as the lifter cover is slid onto the lifter base.

In one or more illustrative examples, the lifter cover defines a lock opening through the lifter cover, sized to receive a snap button of the lifter base, the snap button being supported by a flexible leg extending upwards from the lifter base, such that as the lifter cover is slid onto the lifter base, the snap button rides an inner surface of the lifter cover, causing the flexible leg to bend downwards until the snap button reaches the lock opening to latch into place into the lock opening, and such that the snap button is pressable to free the snap button from the lock opening, allowing the lifter cover to be slid off the lifter base.

In one or more illustrative examples, the lifter base defines a set of latching posts to fit into corresponding through holes defined through the filter element, each of the latching posts may extending upwards from an upper surface of the lifter base and defining a catch at its upper end extending towards the flexible leg, the catches being sized to fit through the through holes to retain the filter element into place between the catches and the lifter base.

In one or more illustrative examples, the bristles are arranged into an array of spaced apart rows and columns of bristle elements, and the cleaning comb comprises a generally flat rectangular base defining an array of pass throughs corresponding to the bristles as arranged, allowing the cleaning comb to fit between the rows and columns of the array of bristles of the filter element.

In one or more illustrative examples, the filter element comprises a hinge snap of the snap-on hinge assembly defining a semi-circular hinge channel, and the cleaning comb defines a pivot pin of the snap-on hinge assembly, parallel to and spaced away from the rectangular body of the filter element, such that the hinge snap is attachable to the pivot pin to allow the filter element to rotate freely about the pivot pin, such that the cleaning comb is rotatably positionable flat against the filter element during operation of the laundry treating appliance and pivotable through the bristles of the filter element for cleaning of the filter element.

In one or more illustrative examples, the lifter cover is contoured to vary in height with respect to the lifter base, and the bristles correspondingly vary in height to follow the contour of the inner surface of the lifter cover, allowing the bristles to extend throughout the lifter cover.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a front view of a clothes dryer, in accordance with one or more embodiments of the disclosure;

FIG. 2A illustrates an interior view of the drum of the clothes dryer of FIG. 1, with a removable filter apparatus in an installed state;

FIG. 2B illustrates an interior view of the drum of the clothes dryer of FIG. 1, with a removable filter apparatus of an alternate design in an installed state;

FIG. 2C illustrates an interior view of the drum of the clothes dryer of FIG. 1, with a removable filter apparatus of a third design in an installed state;

FIG. 2D illustrates an interior view of the drum of the clothes dryer of FIG. 1, with the removable filter apparatus in an uninstalled state;

FIG. 3 illustrates an example exploded perspective view of the components of the removable filter apparatus;

FIG. 4 illustrates an example perspective view of the underside of the lifter base;

FIG. 5 illustrates an example perspective view of the underside of the lifter cover;

FIG. 6 illustrates an example perspective view of the filter element;

FIG. 7 illustrates an example perspective view of the cleaning comb;

FIG. 8A illustrates an example perspective view of the removable filter apparatus in an assembled state;

FIG. 8B illustrates an example front view of the removable filter apparatus in the assembled state;

FIG. 8C illustrates an example plan view of the removable filter apparatus in the assembled state;

FIG. 9 illustrates an example perspective view of the lifter cover being removed from the removable filter apparatus;

FIG. 10 illustrates an example perspective view of the filter element being removed from the removable filter apparatus;

FIG. 11 illustrates an example perspective view of the cleaning comb being rotated to remove accumulated debris;

FIG. 12 illustrates an example exploded perspective view of an alternate removable filter apparatus;

FIG. 13A illustrates an example plan view of the alternate lifter cover;

FIG. 13B illustrates an example front view of the alternate lifter cover;

FIG. 14A illustrates an example perspective view of the alternate lifter cover showing the wash fluid flowing into and then out of the lifter cover;

FIG. 14B illustrates an example perspective view of the underside of the alternate lifter cover showing the wash fluid flowing into and then out of the lifter cover;

FIG. 15 illustrates an example exploded perspective view of another alternative removable filter apparatus;

FIG. 16A illustrates an example bottom perspective view of the lifter base;

FIG. 16B illustrates an example top perspective view of the lifter base;

FIG. 17A illustrates an example bottom perspective view of the lifter cover;

FIG. 17B illustrates an example top perspective view of the lifter cover;

FIG. 18 illustrates an example perspective view of the filter rod;

FIG. 19 illustrates an example perspective view of the sieve;

FIG. 20A illustrates an example cross-sectional perspective view of the assembled removable filter apparatus of FIG. 15;

FIG. 20B illustrates an example cross-sectional side view of the assembled removable filter apparatus of FIG. 15;

FIG. 21A illustrates an example perspective view of the operation of the assembled removable filter apparatuses when the drum is rotating in a clockwise direction;

FIG. 21B illustrates an example perspective view of the operation of the assembled removable filter apparatuses when the drum is rotating in a counter-clockwise direction;

FIG. 22A illustrates a first step for the cleaning of the filter rod of the removable filter apparatus;

FIG. 22B illustrates a second step for the cleaning of the filter rod of the removable filter apparatus;

FIG. 22C illustrates a third step for the cleaning of the filter rod of the removable filter apparatus;

FIG. 22D illustrates a fourth step for the cleaning of the filter rod of the removable filter apparatus;

FIG. 23A illustrates a first step for the reassembly of the removable filter apparatus;

FIG. 23B illustrates a second step for the reassembly of the removable filter apparatus;

FIG. 23C illustrates a third step for the reassembly of the removable filter apparatus;

FIG. 23D illustrates a fourth step for the reassembly of the removable filter apparatus;

FIG. 24 illustrates an example perspective view of yet another alternative removable filter apparatus;

FIG. 25A illustrates an example perspective view of the removable filter strip loaded into the turning flap;

FIG. 25B illustrates an example perspective view of the removable filter strip partially removed from the turning flap;

FIG. 25C illustrates an example perspective view of the removable filter strip completely removed from the turning flap;

FIG. 26 illustrates an example perspective view of the gearing that provides for rotation of the turning flaps of turning flap assembly;

FIG. 27 illustrates an example section perspective view showing details of the turning knob of the lifter body;

FIG. 28 illustrates an example section side view showing details of the operation of the gears of the lifter body; and

FIG. 29 illustrates an example section side view showing details of the attachment of the turning flaps to the gears.

The components in the figures are not necessarily to scale, emphasis instead being placed upon illustrating the principles described herein.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

A removable filter apparatus for a laundry treating appliance may include a lifter cover, a filter element and a cleaning comb. The lifter cover may define a generally rectangular prism shape with an open rectangular bottom, the lifter cover being slidably attachable along the open rectangular bottom to a lifter base of an inner circumferential surface of a drum of the laundry treating appliance, the lifter cover defining through openings to allow for free flow of water. The filter element may be selectively attachable to the lifter base and sized to fit within the lifter cover to allow an array of bristles extending upward from the filter element to capture particulates within the water flow. The cleaning comb may be hingedly attached to the lifter cover by a snap-on hinge assembly. The cleaning comb may be operable to be rotatably lifted through the filter element to remove pet hair from the bristles of the filter element.

A removable filter apparatus for a laundry treating appliance may include a lifter cover, defining a generally trapezoidal prism shape with an open rectangular bottom and configured to be selectively attachable to a lifter base along the open rectangular bottom, the lifter cover defining through openings to allow for free flow of water, the lifter base and the lifter cover collectively defining a processing space. A chamber wall may extend from an apex of the generally trapezoidal prism shape of the lifter cover downwards towards the open rectangular bottom, the chamber wall dividing the processing space into two water flow paths. Pouch filter elements may be selectively attachable to the lifter cover for placement within the two water flow paths to allow the pouch filter elements to capture particulate within the water flow.

A removable filter apparatus for a laundry treating appliance may include a filter rod defining a triangular prism body having two upper faces, rod ends extending longitudinally outwards from each prism base of the triangular prism body, and bristles extending outwards from the two upper faces of the filter rod. The apparatus may also include a lifter cover, defining a generally trapezoidal prism shape with an open bottom and configured to be selectively attachable along the open bottom to a lifter base of a drum of the removable filter apparatus, the lifter cover defining through openings along longitudinal walls of the lifter cover, and a sieve at an apex of the lifter cover, the interior of the lifter cover defining a pair of rod locks each for receiving a respective one of the rod ends of the filter rod, such that the rod ends are selectively attachable to the lifter cover to secure the filter rod into the lifter cover. During operation of the laundry treating appliance, wash fluid in the drum enters the through openings of the removable filter apparatus, passes through the bristles of the filter rod, and continues through the sieve and out back into the drum.

A removable filter apparatus for a laundry treating appliance may include a lifter cover, defining a generally trapezoidal prism shape. The apparatus may further include a turning flap assembly including a pair of turning flaps rotatably attached to the lifter cover, each of the turning flaps defining a flat rectangular structure with a first face for holding a filter strip and a flat opposite face, each of the turning flaps further comprising a flap gear. The apparatus may further include a turning knob comprising a knob end and a knob gear mated to each of the flap gears, such that rotation of the turning knob causes rotation of each of the turning flaps between a first position in which the filter strip is provided on the exterior of the lifter cover and a second position in which the flat opposite face is provided on the exterior of the lifter cover.

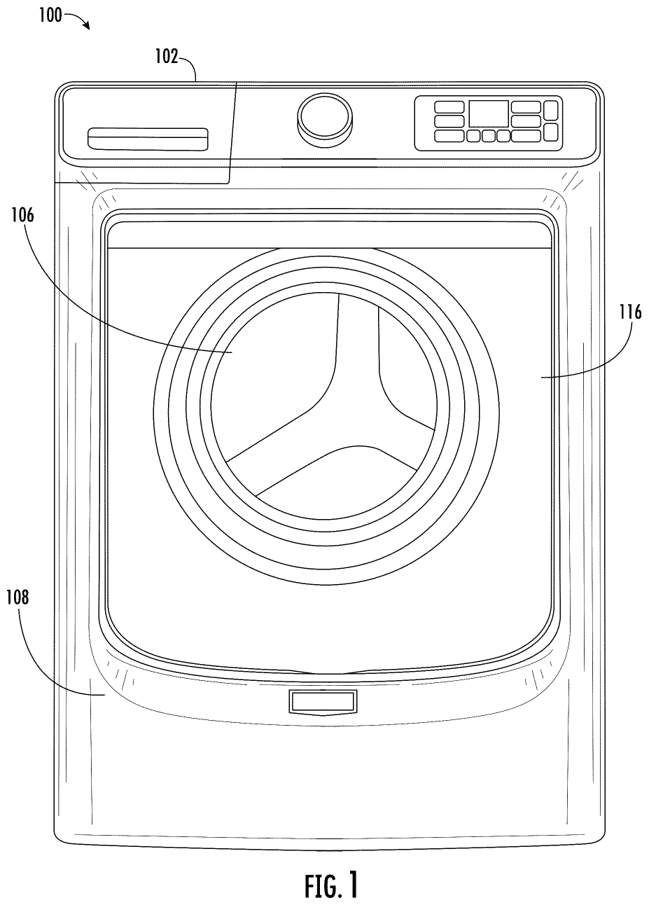

FIG. 1 is a view of a laundry treating appliance 100 configured to utilize a removable filter apparatus 200. The laundry treating appliance 100 may be any machine that treats articles such as clothing or fabrics. Examples of the laundry treating appliance 100 may include, but are not limited to, a horizontal axis washing machine; a horizontal axis dryer (such as a tumble dryer or a stationary dryer), a tumbling or stationary refreshing/revitalizing machine, an extractor, a non-aqueous washing apparatus, and a revitalizing machine. As used herein, the term “horizontal-axis” washing machine refers to a washing machine having a rotatable drum that rotates about a generally horizontal axis relative to a surface that supports the washing machine. However, the rotational axis need not be perfectly horizontal to the surface. For example, the drum may rotate about an axis inclined relative to the horizontal axis (e.g., with fifteen degrees of inclination being one example of the inclination).

As illustrated in FIG. 1, the laundry treating appliance 100 may include a cabinet 102. The cabinet 102 may be defined by a chassis or frame supporting a front wall 104, as well as a rear wall, and a pair of side walls supporting a top wall (not shown). The cabinet 102 may house a stationary tub (not shown). A rotatable drum 106 may be mounted within the tub 108 to define a fabric treatment chamber. The drum 106 may define a plurality of perforations 114 to allow wash fluid 110 to flow between the tub 108 and the drum 106 through the perforations 114. The wash fluid 110 may include water, detergent, etc. A motor may be coupled to the drum 106 through a belt to rotate the drum 106. Both the tub 108 and the drum 106 may be selectively closed by a door 116. The door 116 may be hingedly mounted to the front wall 104 and may be selectively moveable between opened and closed positions to close an opening in the front wall 104, which provides access to the interior of the rotatable drum 106. In the open position, a user can access a processing space 118 defined within the drum 106 for manipulating the removable filter apparatus 200 contained therein.

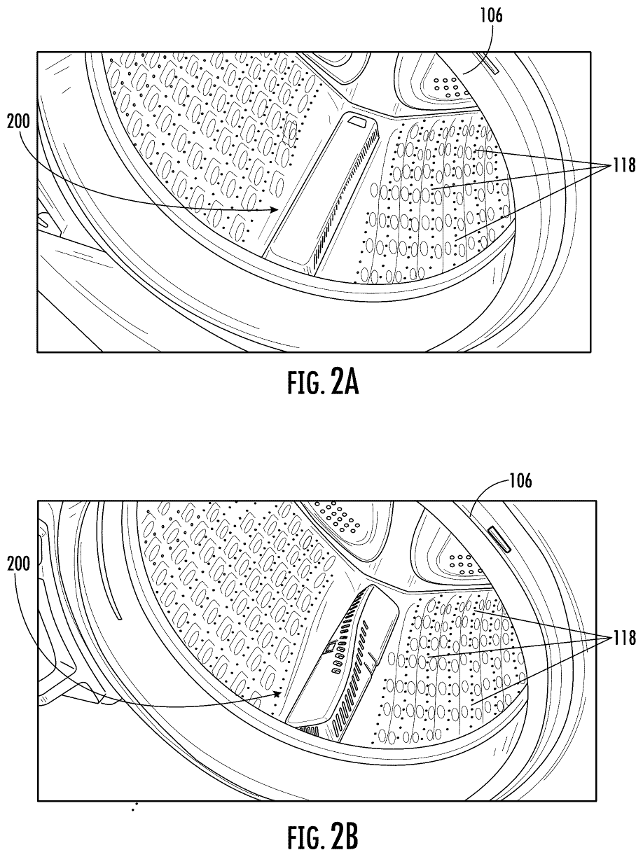

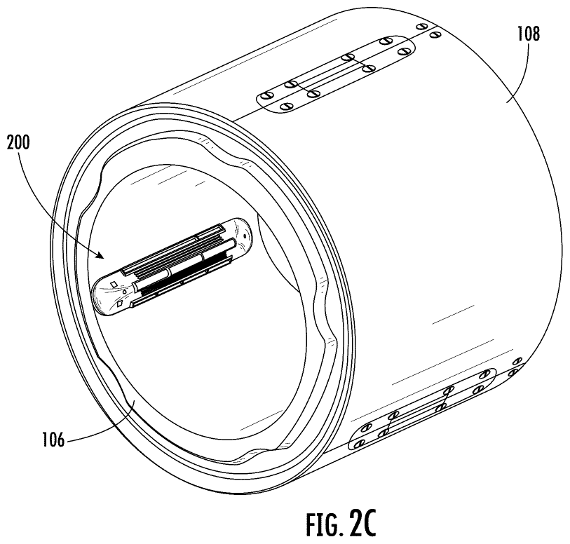

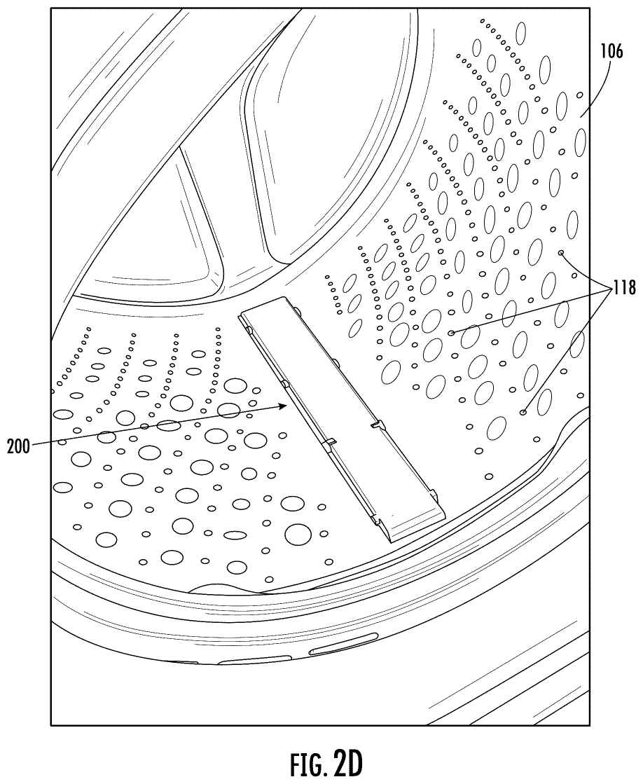

FIG. 2A illustrates an interior view of the drum 106 of the laundry treating appliance 100 of FIG. 1, with a removable filter apparatus 200 in an installed state. FIG. 2B illustrates an interior view of the drum of the clothes dryer of FIG. 1, with a removable filter apparatus 200 of an alternate design in an installed state. FIG. 2C illustrates an interior view of the drum of the clothes dryer of FIG. 1, with a removable filter apparatus 200 of a third design in an installed state.

As explained in detail herein, the inner peripheral surface of the drum 106 may provide for the installation of one or more removable filter apparatus 200. The removable filter apparatus 200 may function as a lifter so as to help clothes or other laundry items to move around the drum 106 as the drum 106 rotates during a laundry cycle. During operation of the laundry treating appliance 100, the removable filter apparatus 200 may also be utilized to capture lint, hair, or other particulate from the wash fluid 110 that flows through a filter cavity 202 defined by the components of the removable filter apparatus 200.

FIG. 2D illustrates an interior view of the drum 106 of the clothes dryer of FIG. 1, with the removable filter apparatus 200 in an uninstalled state. In such a state, the lifter base 302 may be seen embedded in the wall of the drum 106, without attachment of the lifter cover 304.

While only a single removable filter apparatus 200 is shown in FIGS. 2A-2C, there may be multiple such removable filter apparatus 200 arranged around the inner peripheral surface of the drum 106. For example, there may be three, four, or five removable filter apparatus 200 arranged within the drum 106. While removed, the removable filter apparatus 200 may be cleaned and such captured lint, hair, etc., may be cleared from the removable filter apparatus 200.

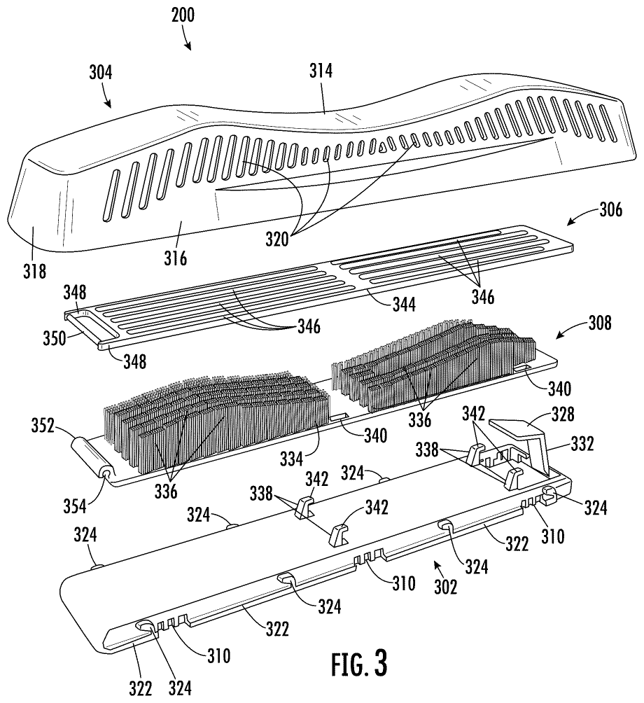

FIG. 3 illustrates an exploded perspective view of the components of the removable filter apparatus 200. As shown, the components of the removable filter apparatus 200 include a lifter base 302, a lifter cover 304, a filter element 306, and a cleaning comb 308. The lifter base 302 may be fixed to the drum 106 and may define a generally rectangular surface configured for receiving the lifter cover 304. The lifter cover 304 may define the exterior appearance of the removable filter apparatus 200, and may be configured to be removably attached to the lifter base 302. The filter element 306 may also be configured to be removably attached to the lifter base 302 and may be sized to fit within the lifter cover 304 when the lifter cover 304 is attached to the lifter base 302. The cleaning comb 308 may be hingedly attached to the filter element 306 and may be operable to be rotatably lifted through filter element 306 to remove pet hair from the filter element 306. As used herein, the inner end of the lifter base 302, lifter cover 304, filter element 306, and cleaning comb 308 refers to the end that is furthest into the drum 106 when the removable filter apparatus 200 is installed, while the outer end of the lifter base 302, lifter cover 304, filter element 306, and cleaning comb 308 refers to the end that is closest to the door 116 when the removable filter apparatus 200 is installed.

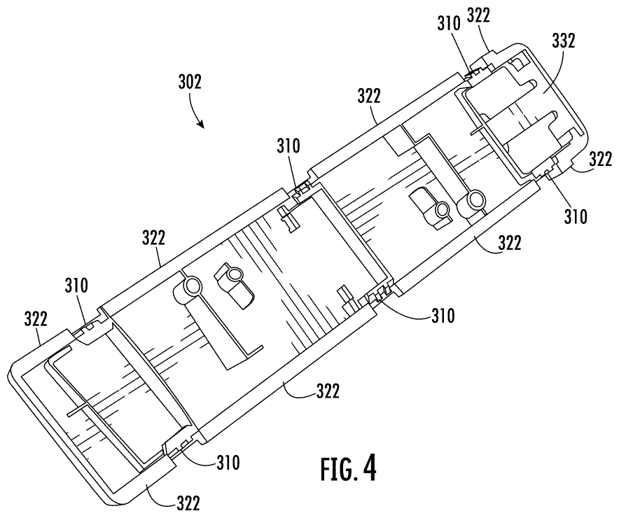

FIG. 4 illustrates a perspective view of the underside of the lifter base 302. As shown, the lifter base 302 may include various features to facilitate attachment of the lifter base 302 to the drum 106. In an example, the lifter base 302 may define one or more attachment mechanisms, specifically referred to as snaps fasteners 310 herein, to be received into corresponding components of the interior of the drum 106 (not shown). As shown, three snaps fasteners 310 are provided on either longitudinal side of the lifter bases 302 for retaining the lifter base 302 into a generally rectangular opening (not shown) in the drum 106. In other examples of attachment mechanisms, the lifter base 302 may be fixed to the drum 106 by way of screws, pins, rivets, and/or glue. In yet a further example (not shown), the lifter base 302 may be integral to the drum 106. In some examples, the attachment features of the lifter base 302 may be consistent with those of a single-piece non-removable lifter, to allow for seamless installation or retrofit of the removable filter apparatus 200 into laundry treating appliances 100 with traditional fixed lifters.

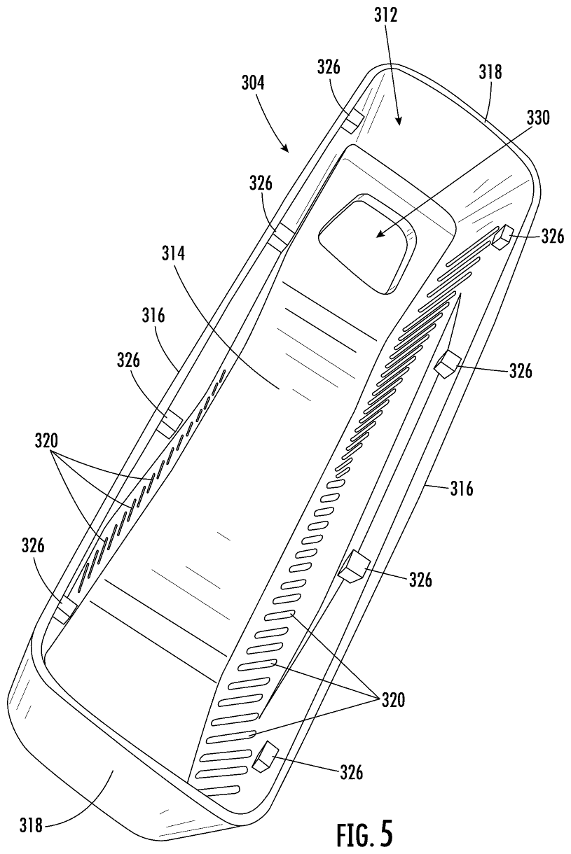

FIG. 5 illustrates a perspective view of the underside of the lifter cover 304. The lifter cover 304 comprises an upper face 314, longitudinal walls 316 extending downward from the upper face 314 along the longitudinal sides of the lifter cover 304, and end caps 318 at either end of the lifter cover 304 that connect between the longitudinal walls 316 to define a generally rounded rectangular shape with an open rectangular bottom 312. The upper face 314, longitudinal walls 316, and end caps 318 may be of a generally consistent thickness. The corners where the end caps 318 meet the longitudinal walls 316 may be rounded to provide for better flow of wash fluid 110 and laundry items around the lifter cover 304. In many examples, the lifter cover 304 may be formed as a single plastic body.

As best seen in FIG. 3, the upper face 314 of the lifter cover 304 defines an undulating upper surface. For instance, the upper face 314 may define two equally sized bulges centered at approximately one quarter the length of the upper face 314 and three quarters the length of the upper face 314, with a depression in-between. It should be noted that the upper contour is only an example and upper faces 314 with different contours are possible.

The longitudinal walls 316 of the lifter cover 304 may define various through openings 638 to allow for the free flow of water into and out of the lifter cover 304. Accordingly, whether the drum 106 is rotating in a clockwise direction and/or a counter clockwise direction, wash fluid 110 is permitted to pass through the processing space 118 of the lifter cover 304, such as during an agitating portion of a wash cycle. As shown, the through openings 638 are formed as a series of equally-spaced slots along the face of the longitudinal walls 316, parallel to the closet end cap 318, with a smaller triangular opening 638 at the center of the pattern. The openings 638 in the illustrated example are sized to prevent laundry articles from entering the lifter cover 304, but still allowing for smaller particles to enter the lifter cover 304. It should be noted that the specific pattern of through openings 638 is exemplary and other patterns may be contemplated.

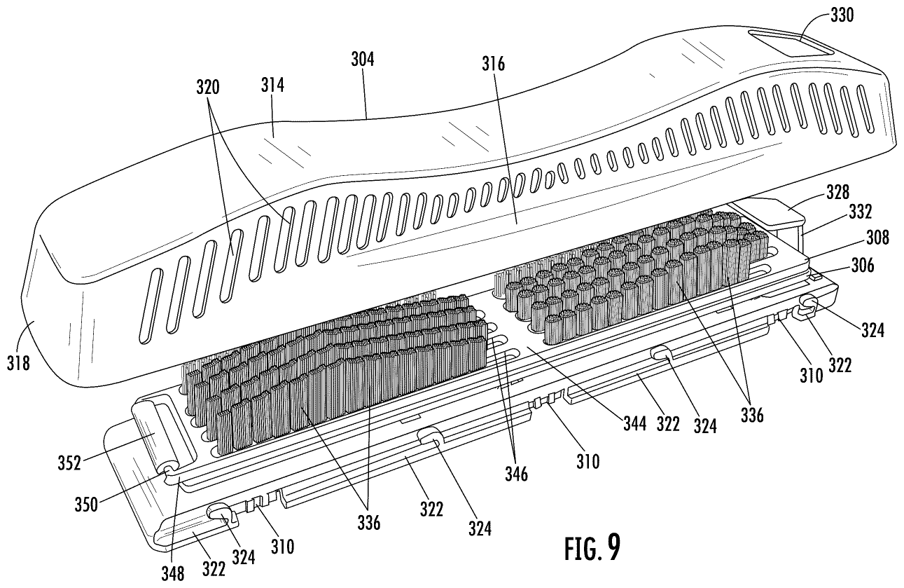

The lifter cover 304 further defines features to facilitate attachment of the lifter cover 304 onto the lifter base 302. These features allow the lifter cover 304 to be secured to the lifter base 302 during operation of the laundry treating appliance 100. As shown at least in FIGS. 3 and FIG. 9, the lifter base 302 defines guide rails 322 extending outward from its sidewalls along the length of the lifter base 302, as well as a plurality of engaging hooks 324 extending longitudinally above the guide rails 322. When attached to the lifter base 302, the combination of the lifter base 302 and the lifter cover 304 may define an inner volume. This inner volume can be described as the filter cavity 202 that is contained within the removable filter apparatus 200 for use within the drum 106. This open rectangular bottom 312 of the lifter cover 304 allows wash fluid 110 to pass through the filter cavity 202 by moving through the perforations 114 of the drum 106.

As best seen in FIG. 5, the lifter cover 304 defines a corresponding plurality of internal projections 326 along the length of the internal edges of the open rectangular bottom 312. These internal projections 326 extend laterally into the interior area defined by the lifter cover 304. The engaging hooks 324 may be sized and positioned to receive the internal projections 326 of the lifter cover 304. The internal projections 326 may be spaced away from the bottom edge of the lifter cover 304 to allow the bottom faces of the internal projections 326 to slide along the guide rails 322 into the engaging hooks 324, thereby securing the lifter cover 304 to the lifter base 302. In some examples, the internal projections 326 may form tapered protrusions that widen in the insertion direction to match the contour of the engaging hooks 324. The lifter cover 304 may accordingly be attached to the lifter base 302 by sliding the lifter cover 304 longitudinally onto the lifter base 302 with the first end cap 318 facing (e.g., into the drum 106), and may be detached from the lifter base 302 by sliding the lifter cover 304 longitudinally off the lifter base 302 in the opposite direction (e.g., towards the door 116 out of the drum 106).

In one example, the lifter base 302 defines four equally spaced engaging hooks 324 along each long side of the lifter base 302, while the lifter cover 304 defines four corresponding internal projections 326 along each long side of the lifter cover 304. It should be noted that this is only one example, and different arrangements of engaging hooks 324 and internal projections 326 may be used. It should further be noted that the engaging hooks 324 and internal projections 326 may be reversed, and the lifter cover 304 may instead define the engaging hooks 324 to capture projections extending outward from the lifter base 302.

The lifter base 302 may further define a snap button 328 sized to fit into a lock opening 330 in the upper face 314 of the lifter cover 304. The snap button 328 may be supported by a flexible leg 332 extending upwards from the inner end of the lifter base 302 (the end furthest inside the drum 106). As the lifter cover 304 is slid onto the lifter base 302, the snap button 328 rides the inner surface of the upper face 314 of the lifter cover 304, causing the flexible leg 332 to bend downwards. Once the snap button 328 reaches the lock opening 330, the flexible leg 332 relaxes upwards, allowing the snap button 328 to latch into place into the lock opening 330. Thus, the lifter cover 304 is locked into place. To remove the lifter cover 304 from the lifter base 302, the operator may press down on the snap button 328 to free the snap button 328 from the lock opening 330, and then slide the lifter cover 304 towards the front wall 104 and off the lifter base 302.

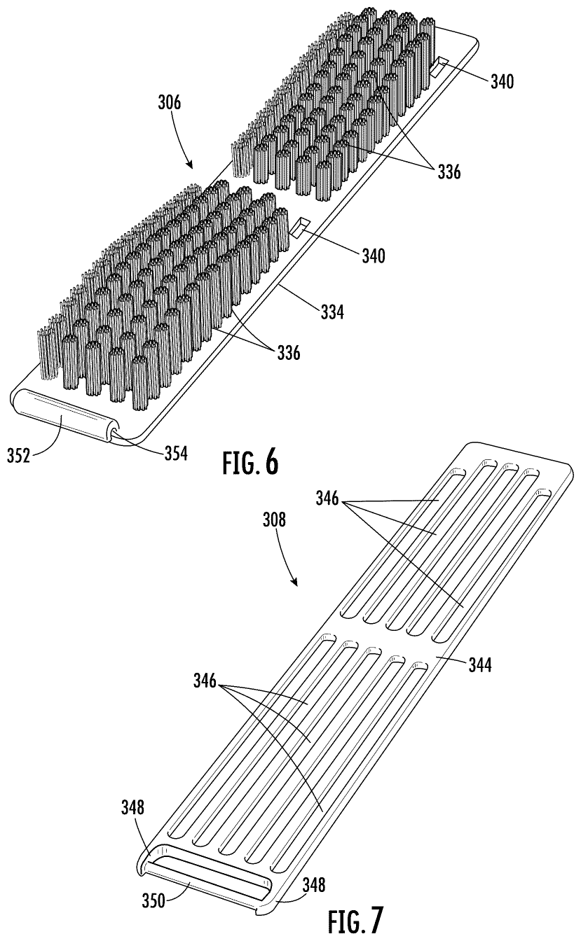

Referring to FIG. 6, the filter element 306 defines a rectangular base 334 sized to fit within the open rectangular bottom 312 of the lifter cover 304. The rectangular base 334 may define a generally flat, rectangular surface. The filter element 306 further defines an array of bristles 336, extending upward from the rectangular base 334. The bristles 336 may define surfaces for the free flow of wash fluid 110 and the capture of particulate. The bristles 336 may be made of various materials, such as metals (e.g., brass, bronze, carbon steel, stainless steel, etc.), natural fibers (e.g., horsehair, goat hair, Tampico, etc.), and/or synthetic materials (e.g., nylon, polyvinyl chloride, polyethylene, styrene, polystyrene, etc.). In some examples the bristles 336 may be a tuft or other grouping of multiple thin elements, while in other examples the bristles 336 may each define a single larger bristle 336.

The array of bristles 336 may include a plurality of substantially parallel spaced apart rows and columns of upright spaced bristles 336. For example, a plurality of substantially parallel spaced apart rows of upright brushed hairs may be spaced apart from each other in a substantially regular group. As shown the array of bristles 336 includes two such groupings, corresponding to the two taller areas of the filter cavity 202. The height of the bristles 336 allows for the filter element 306 to extend upwards within the processing space 118 of the lifter cover 304. As shown, the bristles 336 may be of varying height following the contour of the inner face of the upper face 314, to extend throughout the varying height of the filter cavity 202.

The filter element 306 may be attachable to the lifter base 302 through a set of latching posts 338 configured to fit into corresponding through holes 340 defined through the surface of the bristle filter element 306. Each of the latching posts 338 may extend upwards from the upper surface of the lifter base 302 and may define a catch 342 at its upper end extending towards the flexible leg 332, i.e., the inner end of the removable filter apparatus 200. The catches 342 may be sized to fit through the through holes 340 and retain the filter element 306 into place between the catches 342 and the lifter base 302. As seen in FIG. 3, four latching posts 338 are used, two around the midpoint of the longitudinal sides of the lifter base 302 and two near the inner end of the lifter base 302, but this is only an example, and more, fewer, and/or differently located latching posts 338 may be used.

To attach the filter element 306 to the lifter base 302, the filter element 306 may be aligned such that the through holes 340 are above the latching posts 338. The filter element 306 may then be pushed down onto the latching posts 338 and then slid towards the opening to the drum 106 to latch the filter element 306 into place. To remove the filter element 306, a reverse operation may be performed, where the filter clement 306 is slid towards the flexible legs 332 and lifted upwards.

As best seen in FIG. 7, the cleaning comb 308 may define a generally flat rectangular base 344. The base 344 may include teeth supports that define an array of pass throughs 346 corresponding to the placement of the bristles 336, allowing the supports of the cleaning comb 308 to fit between the rows and columns of the array of bristles 336 of the filter element 306. The cleaning comb 308 may further define mounts 348 projecting from the outer ends of each longitudinal side of the cleaning comb 308. The mounts 348 may be bridged by a pivot pin 350 which is parallel to and spaced away from the rectangular base 344 of the filter element 306.

Returning to FIGS. 3 and 6, the outer end of the filter element 306 defines a hinge snap 352 having a generally U-shaped or semi-circular hinge channel 354. The hinge snap 352 may be snapped to the pivot pin 350 (such as illustrated in FIGS. 3 and 7). When snapped on, the hinge snap 352 allows the filter element 306 to rotate freely about the pivot pin 350.

The cleaning comb 308 may be assembled onto the filter element 306, and the filter element 306 may be attached to the lifter base 302. Then, the lifter cover 304 may be attached to the lifter base 302 above the filter element 306. These components as installed form the removable filter apparatus 200. The removable filter apparatus 200 includes the outer apertures or other through openings 638 that are defined by the longitudinal walls 316 of the lifter cover 304. These through openings 638 prevent larger items and particulate from entering into the inner volume of the lifter cover 304. The particulate filter also includes the filter element 306 contained in the filter cavity 202 for capturing fine particulate via the bristles 336. Together, the particulate filter provides a multi-function filtering device within the processing space 118 of the drum 106.

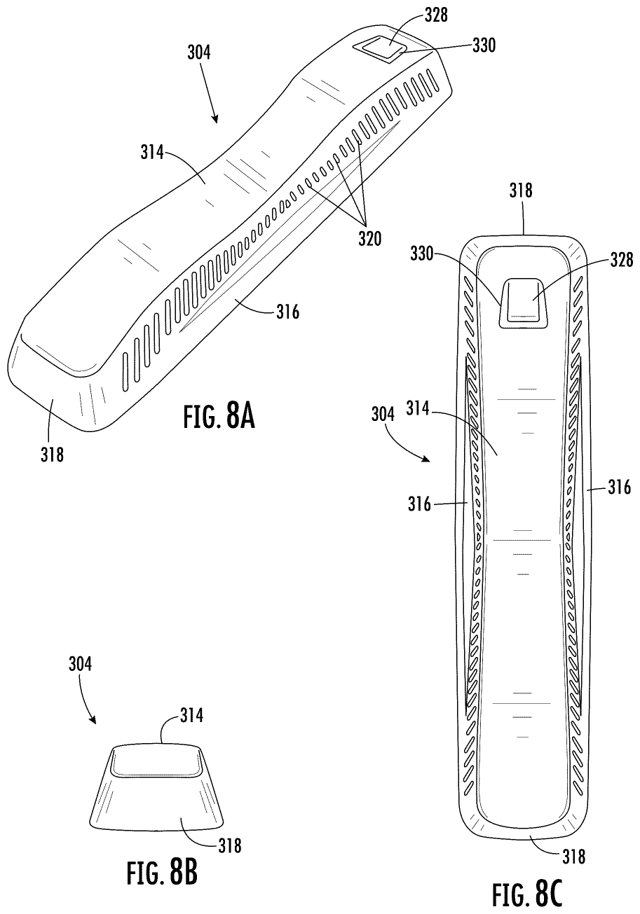

FIG. 8A illustrates an example perspective view of the removable filter apparatus 200 in an assembled state. FIG. 8B illustrates an example front view of the removable filter apparatus 200 in the assembled state. FIG. 8C illustrates an example plan view of the removable filter apparatus 200 in the assembled state.

Before a laundry cycle of the laundry treating appliance 100, an operator may slide the filter element 306 downwards and then longitudinally outwards onto the catches 342. The operator may further install the lifter cover 304 longitudinally onto the lifter base 302 in the drum 106. As the lifter cover 304 is slid longitudinally onto the lifter base 302, the bottom faces of the internal projections 326 slide along the guide rails 322 into the engaging hooks 324, while at the same time the upper face 314 provide a surface for the snap button 328 to ride. The flexible leg 332 may accordingly flex downwards as the lifter cover 304 is slid onto the lifter base 302 and then resiliently flex back toward its original position once the snap button 328 passes into the lock opening 330. The snap button 328 may engage the lock opening 330, inhibiting movement of the lifter cover 304 off the lifter base 302.

Once attached, the laundry cycle may be performed. During the cycle, water may flow into and out of the lifter cover 304 through the openings 638. This wash water may travel through the bristles 336 of the filter element 306, thereby causing particulate from the wash to be captured.

Once the cycle is complete, the operator may remove the lifter cover 304 from the lifter base 302. FIG. 9 illustrates an example perspective view of the lifter cover 304 being removed from the removable filter apparatus 200. For example, the operator may press the snap button 328, to free the snap button 328 from the lock opening 330 and allow the lifter cover 304 to slide longitudinally off of the lifter base 302.

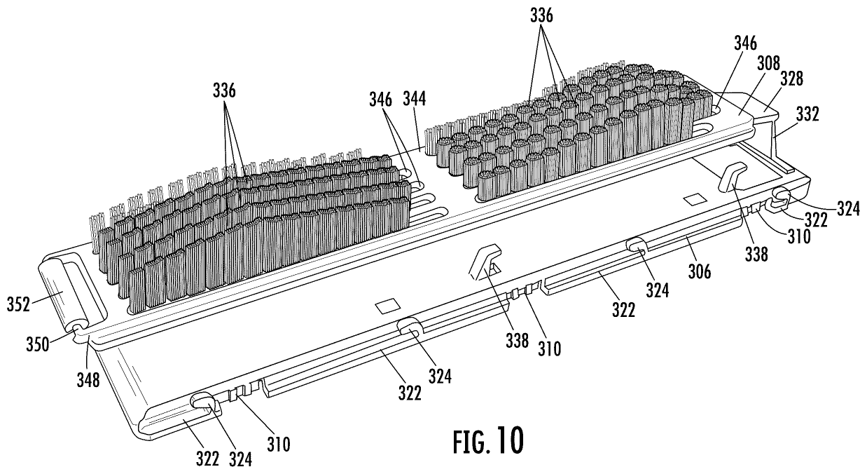

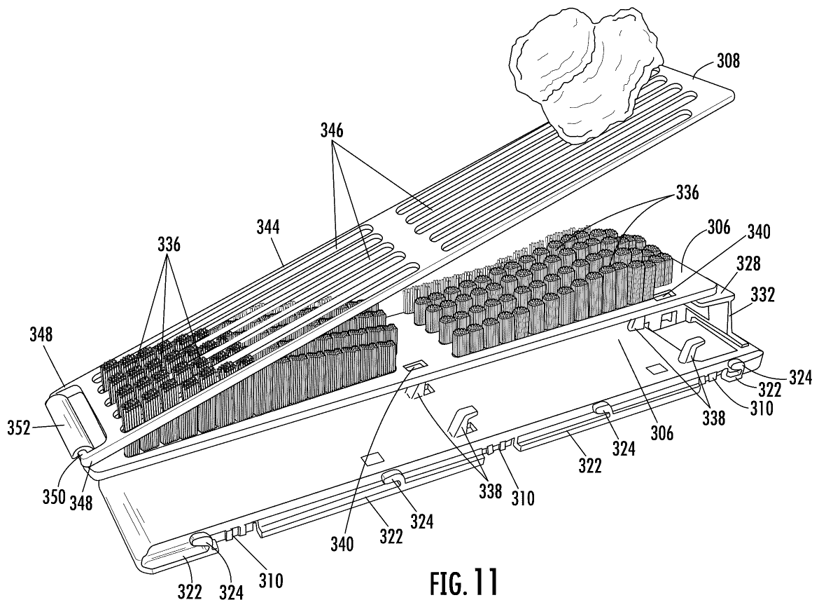

To clean the filter element 306, the operator may slide the filter element 306 forwards and then upwards off the catches 342. FIG. 10 illustrates an example perspective view of the filter element 306 being removed from the removable filter apparatus 200.

Once removed, the operator may lift the cleaning comb 308, which may pass between the bristles 336 to remove accumulated pet hair or other particulate. FIG. 11 illustrates an example perspective view of the cleaning comb 308 being rotated to remove accumulated debris. By using the cleaning comb 308, the hair removal is easily performed and the operator does not have to touch or interact too much with wet pet hair accumulated inside the bristles 336. Once cleaned, the cleaning comb 308 may be rotated back down, the filter element 306 may be reattached to the catches 342, and the lifter cover 304 may be replaced over the filter element 306 for further use.

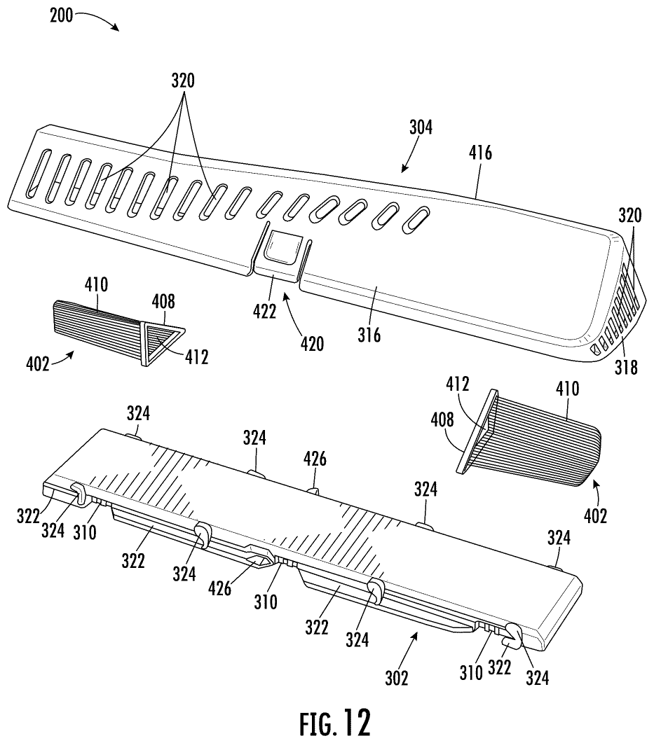

FIG. 12 illustrates an exploded perspective view of the components of an alternate removable filter apparatus 200. These include the lifter base 302, a lifter cover 304 of a different design, and two pouch filter elements 402. As before, the lifter base 302 may be fixed to the drum 106 and may define a generally rectangular surface configured for receiving the lifter cover 304. The lifter cover 304 may define the exterior appearance of the removable filter apparatus 200, and may be configured to be removably attached to the lifter base 302. The pouch filter elements 402 may define pouches sized to fit within each longitudinal end of the lifter cover 304 when the lifter cover 304 is attached to the lifter base 302.

The lifter cover 304 may define a generally trapezoidal prism shape with an open rectangular bottom 312. This open lower section of the lifter cover 304 allows wash fluid 110 to pass through the filter cavity 202 by moving through the perforations 114 of the drum 106. As shown, the lifter cover 304 defines two generally trapezoidal longitudinal walls 316 of a generally consistent thickness along the longitudinal direction of the lifter cover 304, and two generally triangular end caps 318 at either end of the lifter cover 304 that connect between the longitudinal walls 316 and the open rectangular bottom 312. The end caps 318 may taper inward towards the apex 416 of the lifter cover 304, such that the length of the lifter cover 304 at the apex 416 is less than the length of the lifter cover 304 at the rectangular bottom. In many examples, the lifter cover 304 may be formed as a single plastic body.

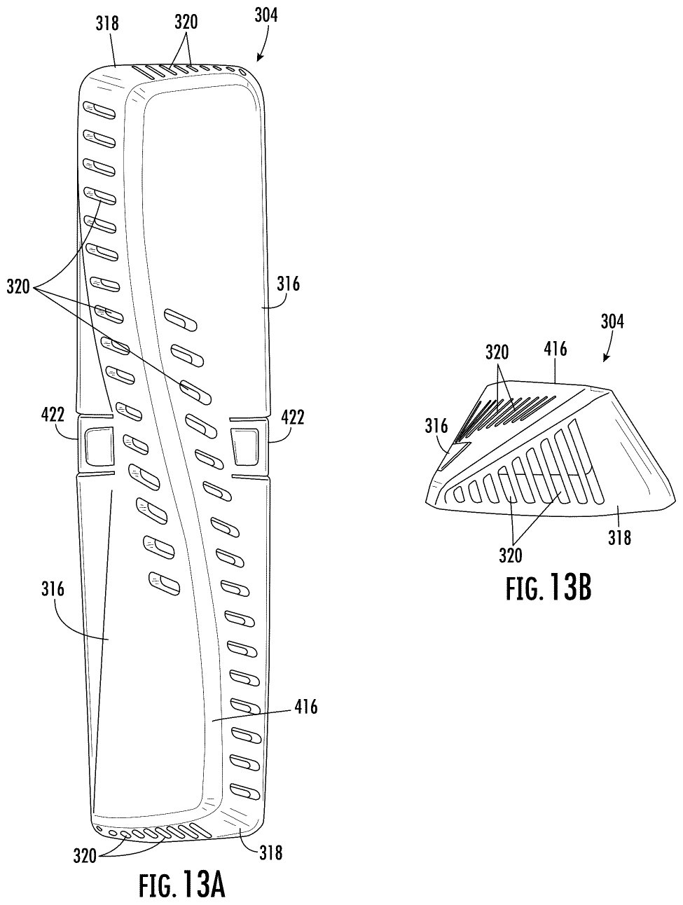

As best seen in FIGS. 13A and 13B, the apex 416 of the lifter cover 304 may define a curved shape, such as an S-curve or a sinusoidal curve. As before, the longitudinal walls 316 of the lifter cover 304 define various through openings 638 to allow for the free flow of water into the lifter cover 304. Additionally, the end caps 318 define further through openings 638 to allow for the free flow of water out of the lifter cover 304. As shown, the through openings 638 along the face of the longitudinal walls 316 and the end caps 318 are formed as a series of equally-spaced slots running substantially parallel to the corners formed between the longitudinal walls 316 and end caps 318. Accordingly, whether the drum 106 is rotating in a clockwise direction and/or a counter clockwise direction, wash fluid 110 is permitted to pass through the processing space 118 of the lifter cover 304, such as during an agitating portion of a wash cycle. The openings 638 in the illustrated example are sized to prevent laundry articles from entering the lifter cover 304, but still allowing for smaller particles to enter the lifter cover 304. It should be noted that the specific pattern of through openings 638 is exemplary and other patterns may be contemplated.

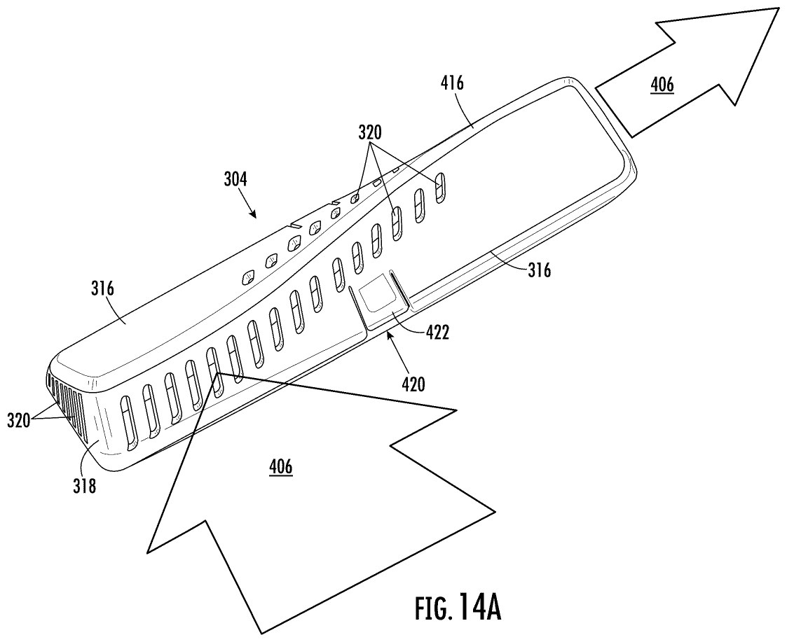

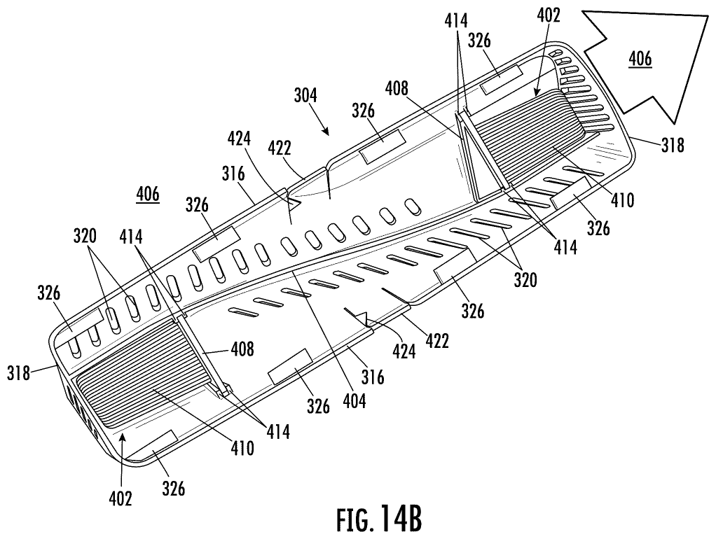

FIG. 14A illustrates an example perspective view of the lifter cover 304 showing the wash fluid 110 flowing into and then out of the lifter cover 304. FIG. 14B illustrates an example perspective view of the underside of the lifter cover 304 showing the wash fluid 110 flowing into and then out of the lifter cover 304.

As best seen in FIG. 14B, a chamber wall extends from the apex 416 of the lifter cover 304 downwards towards the open rectangular bottom 312. The chamber wall 404 begins laterally closer to the first of the longitudinal walls 316 such that the through openings 638 on first attached end cap 318 are at least partially blocked off from the through openings 638 of the closer longitudinal wall 316. The chamber wall 404 then follows the curve of the apex 416 of the lifter cover 304 to connect to the opposite end cap 318 laterally closer to the opposite longitudinal walls 316 such that the through openings 638 on the opposite attached end cap 318 are open to the flow path. Thus, the chamber wall 404 connects between the end caps 318 to divide the filter cavity 202 into two flow paths—a first flow path 406 (as shown) from the through openings 638 on a first of the longitudinal walls 316 to a first of the end caps 318, and a second flow path 406 (not shown) from the through openings 638 on the second of the longitudinal walls 316 to second of the end caps 318.

The pouch filter elements 402 may be placed into these first and second paths 406. Referring back to FIG. 12, the pouch filter elements 402 may comprise a triangular frame 408 to which a mesh pouch 410 is attached. The triangular frame 408 may define an open interior configured to receive the wash fluid 110. The mouth 412 of the mesh pouch 410 may be attached to the periphery of the triangular frame 408, serving to hold the mouth 412 of the mesh pouch 410 open to receive wash fluid 110 along one of the water flow paths 406 through the filter cavity 202. The mesh pouch 410 may be of a metallic screen or other type of filtration material sized to allow wash fluid 110 to pass but to capture hair or other particulate in the wash fluid 110.

The triangular frame 408 may be sized to be received within filter mounts 414 defined in the underside of the lifter cover 304. In an example the filter mounts 414 may define a pair of spaced apart ridges on the inner surface of the upper face 314 as well as on the adjacent side of the chamber wall 404. The filter mounts 414 may be placed along the flow paths 406 to allow the pouch filter elements 402 to be installed with their respective mouths 412 open to receive particulate in the wash fluid 110.

As best seen in FIG. 14B, and as discussed above, the lifter cover 304 defines a plurality of internal projections 326 along the length of the internal edges of the open rectangular bottom 312. These internal projections 326 extend laterally into the interior area defined by the lifter cover 304. The engaging hooks 324 of the lifter base 302 may be sized and positioned to receive the internal projections 326 of the lifter cover 304. The internal projections 326 may be spaced away from the bottom edge of the lifter cover 304 to allow the bottom faces of the internal projections 326 to slide along the guide rails 322 into the engaging hooks 324, thereby securing the lifter cover 304 to the lifter base 302. In some examples, the internal projections 326 may form tapered protrusions that widen in the insertion direction to match the contour of the engaging hooks 324. The lifter cover 304 may accordingly be attached to the lifter base 302 by sliding the lifter cover 304 longitudinally onto the lifter base 302 with the first end cap 318 facing (e.g., into the drum 106), and may be detached from the lifter base 302 by sliding the lifter cover 304 longitudinally off the lifter base 302 in the opposite direction (e.g., towards the door 116 out of the drum 106).

The lifter cover 304 may define a squeeze latch 420 molded into the body of the lifter cover 304. The squeeze latch 420 may define two resilient latch arms 422, free on the sides and bottom, and connected to the rest of the lifter cover 304 at the top of the lifter cover 304. Due to being free on the sides and bottom, the latch arms 422 may be bent inwards when squeezed together by an operator.

The latch arms 422 may define stops 424 that extend downwards from the latch arms 422. The stops 424 may define vertical surfaces along the insertion direction of the lifter cover 304 onto the lifter base 302. The sides of vertical surfaces may angle upwards towards the longitudinal walls 316 of the lifter cover 304, serving to form a triangular gap between the stops 424 and the inner surface of the longitudinal walls 316.

The lifter base 302 may also define corresponding bosses 426 extending upwards from the guide rails 322 of the lifter base 302. In an example, the bosses 426 may define corresponding vertical surfaces at the same height as the stops 424. The bosses 426 provide a surface for the stops 424 to ride as the lifter cover 304 is slid longitudinally onto the lifter base 302. The two latch arms 422 may accordingly flex toward one another as the lifter cover 304 is slid onto the lifter base 302 and then resiliently flex back toward their original position once the stops 424 pass beyond the bosses 426.

The stops 424 may engage the flat surface behind the bosses 426, inhibiting movement of the lifter cover 304 off the lifter base 302. To uncouple the lifter cover 304, the operator presses the two latch arms 422 together, to allow the legs to move inward and allow the stops 424 to pass around the bosses 426 as the lifter cover 304 is slid off the lifter base 302.

Before a laundry cycle of the laundry treating appliance 100, an operator may slide the pouch filter elements 402 into the filter mounts 414. The operator may then install the lifter cover 304 carrying the pouch filter elements 402 longitudinally onto the lifter base 302 in the drum 106. As the lifter cover 304 is slid longitudinally onto the lifter base 302, the bottom faces of the internal projections 326 slide along the guide rails 322 into the engaging hooks 324, while at the same time the bosses 426 provide a surface for the stops 424 to ride. The two latch arms 422 may accordingly flex toward one another as the lifter cover 304 is slid onto the lifter base 302 and then resiliently flex back toward their original position once the stops 424 pass beyond the bosses 426. The stops 424 may engage the flat surface behind the bosses 426, inhibiting movement of the lifter cover 304 off the lifter base 302.

Once attached, the laundry cycle may be performed. During the cycle, water may flow into and out of the lifter cover 304 through the openings 638. This wash water may travel through the pouch filter elements 402, thereby causing particulate from the wash to be captured in the mesh pouches 410 of the pouch filter elements 402.

Once the cycle is complete, the operator may remove the lifter cover 304 from the lifter base 302. For example, the operator may squeeze the two latch arms 422 of the squeeze latch 420 together, to allow the legs to move inward and allow the stops 424 to pass around bosses 426, and then slide the lifter cover 304 longitudinally off of the lifter base 302. The operator may then slide the pouch filter elements 402 off the filter mounts 414. Once removed, the operator may empty the mesh pouches 410. For example, the operator may reverse the mesh pouches 410 to allow the contents to be easily removed. Once cleaned, the mesh pouches 410 may be returned to their forward position and installed to the filter mounts 414, and the lifter cover 304 may be reattached to the lifter base 302 for further use.

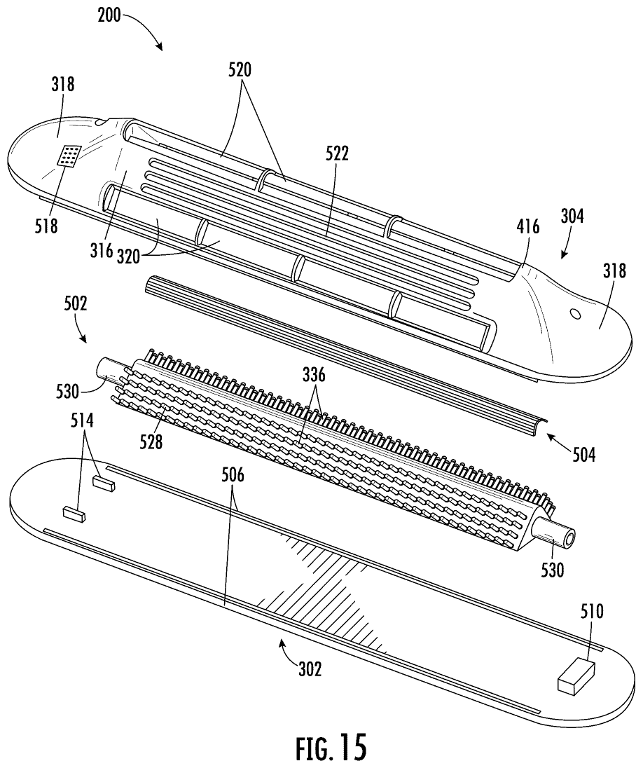

FIG. 15 illustrates an example of another alternative removable filter apparatus 200. As shown, the removable filter apparatus 200 includes a lifter base 302, a lifter cover 304, a filter rod 502, and a sieve 504. The lifter base 302 may be fixed to the drum 106 and may define a generally rectangular surface with rounded corners, configured for receiving the lifter cover 304 of corresponding shape. The lifter cover 304 may define the exterior appearance of the removable filter apparatus 200, and may be configured to be removably attached to the lifter base 302. The filter rod 502 may be configured to be removably attached to the lifter cover 304 and may be sized to fit within the lifter cover 304 when the lifter cover 304 is attached to the lifter base 302. The sieve 504 may be over-molded with the lifter cover 304 to catch leftover pet hair or other particulate that was not captured by the bristles 336 of the filter rod 502.

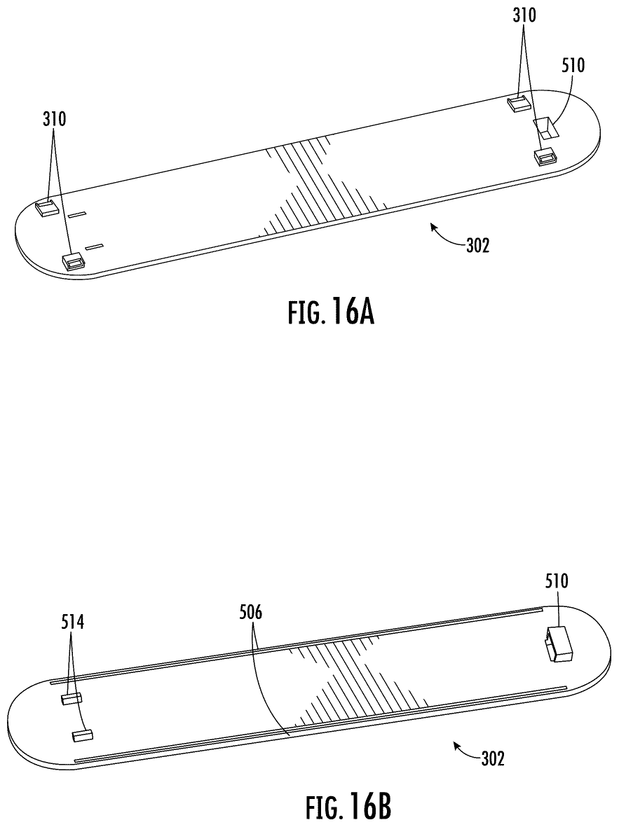

FIG. 16A illustrates a bottom perspective view of the lifter base 302. Referring to FIG. 16A, similar to as noted with the other designs, the lifter base 302 may define one or more attachment mechanisms, specifically referred to as snaps fasteners 310 herein, to be received into corresponding components of the interior of the drum 106 (not shown). As shown, two snaps fasteners 310 are provided on either longitudinal side of the lifter bases 302 for retaining the lifter base 302 into an opening (not shown) in the drum 106. In other examples of attachment mechanisms, the lifter base 302 may be fixed to the drum 106 by way of screws, pins, rivets, and/or glue. In yet a further example (not shown), the lifter base 302 may be integral to the drum 106. In some examples, the attachment features of the lifter base 302 may be consistent with those of a single-piece non-removable lifter, to allow for seamless installation or retrofit of the removable filter apparatus 200 into laundry treating appliances 100 with traditional fixed lifters.

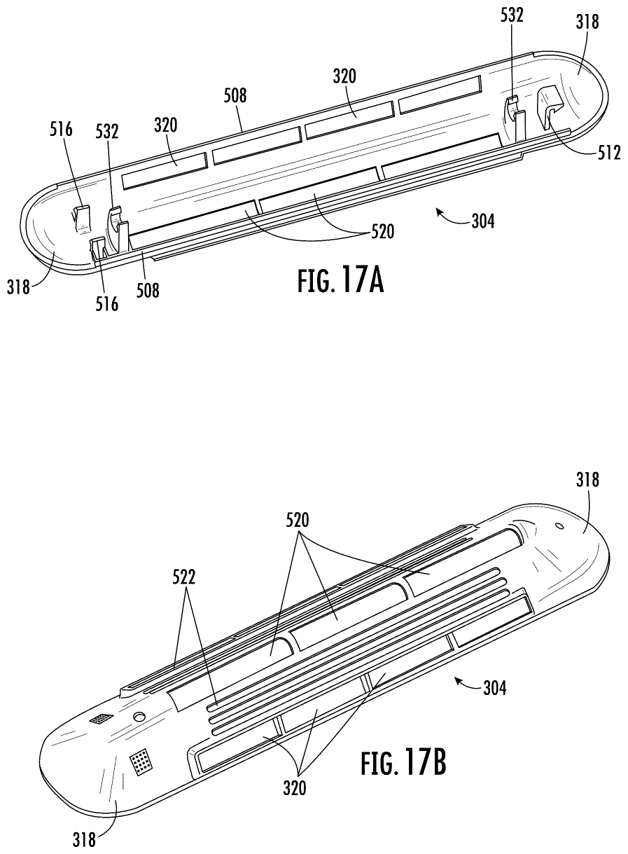

FIG. 16B illustrates a top perspective view of the lifter base 302. FIG. 17A illustrates a bottom perspective view of the lifter cover 304. As shown, the lifter cover 304 comprises two longitudinal walls 316 and two generally semicircular end caps 318 meeting at the apex 416, collectively defining a generally trapezoidal prism shape with rounded end caps 318. As explained herein, the lifter base 302 and lifter cover 304 define various features for the selective attachment of the lifter cover 304 to the lifter base 302.

As best seen in FIG. 16B, the longitudinal sides of the lifter base 302 define grooves 506 along the length of the lifter base 302 for engaging the lifter cover 304. The grooves 506 may extend into the lifter base 302 parallel to and set away from the longitudinal edges of the lifter cover 304. As shown in FIG. 17A, ridges 508 are defined along the longitudinal walls 316 at the open rectangular bottom 312 of the lifter cover 304. These ridges 508 are sized and located to be received into the grooves 506 of the lifter base 302 when the lifter cover 304 is installed to the lifter base 302.

With continuing reference to FIGS. 16B and 17A, a slide 510 is defined near the inner end of the lifter base 302 for receiving a guide 512 of the lifter cover 304 when installed to the lifter cover 304. The slide 510 may define an aperture above the top surface of the lifter base 302 along the direction of installation of the lifter base 302. The guide 512 in turn defines a protrusion set off from the longitudinal walls 316 and end caps 318 of the lifter cover 304 at a height to be received into the slide 510 as the lifter cover 304 is guided by an operator onto the lifter base 302.

On the other side, the lifter base 302 defines one or more snaps 514 extending upwards from the surface of the lifter base 302. These snaps 514 may be sized to be received into snap locks 516 extending downwards from the inner surface of the lifter cover 304. When snapped into the snap locks 516, the snaps 514 serve to hold the lifter cover 304 in place. The lifter cover 304 may also define lock release buttons 518 when, when pressed, causes the snap lock 516 to bend away from the snaps 514, unlocking the lifter cover 304 from the lifter base 302 for removal of the lifter cover 304.

FIG. 17B illustrates a top perspective view of the lifter cover 304. As best seen in FIG. 17B, the longitudinal walls 316 of the lifter cover 304 may define various through openings 638 to allow for the free flow of water into the lifter cover 304. These openings 638 may be provided near the lower extent of the longitudinal walls 316 of the lifter cover 304, allowing for the capture of wash water around the interior periphery of the drum 106. As shown, the openings 638 may be provided as a series of openings of fixed height. Additionally, the lifter cover 304 may define a water outlet 520 along the apex 416 of the lifter cover 304 to allow for the free flow of water out of the lifter cover 304. During operation of the laundry treating appliance 100, a water flow may be established in the openings 638 and out the water outlet 520.

Between the openings 638 at the base of the lifter cover 304 and the water outlet 520 at the apex 416 of the lifter cover 304, the intermediate surface of the lifter cover 304 may define a series of ribs 522 to provide scrubbing action for laundry articles being treated by the laundry treating appliance 100. These ribs 522 may extend along the longitudinal walls 316 in the longitudinal direction parallel with and between the openings 638 and the water outlet 520.

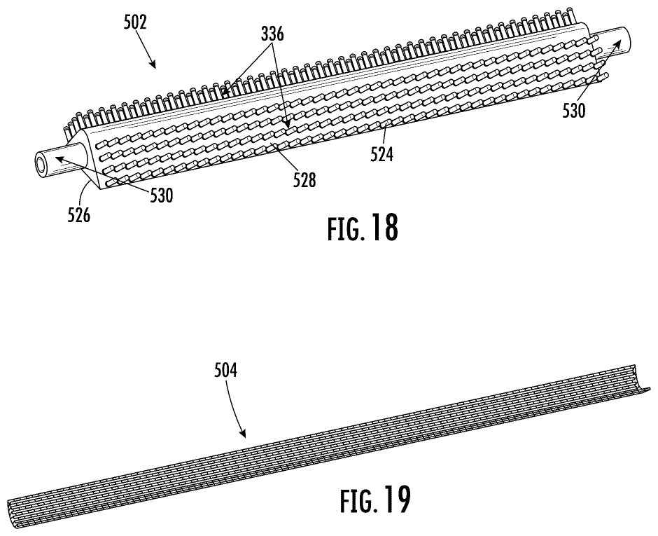

FIG. 18 illustrates an example filter rod 502. As shown, the filter rod 502 defines a triangular prism body 524. As the body 524 is of a triangular prism shape, the filter rod 502 may easily fit into the triangular prism shape of the lifter cover 304. For example, the triangular prism body 524 may define a lower end 526 designed to be placed closest to the open rectangular bottom 312 and the lifter base 302, as well as two upper faces 528 to be placed in proximity to the longitudinal walls 316. The filter rod 502 may also define rod ends 530 extending longitudinally outwards from each base of the triangular prism body 524. In some examples, the lower end 526 may be open to the underside of the two upper faces 528. In other examples, the lower end 526 may be a flat surface enclosing the remaining side of the filter rod 502.

As best seen in FIG. 17A, the underside of the lifter cover 304 may define a pair of rod locks 532. The rod locks 532 may each define a semi-circular channel for receiving the rod ends 530 of the filter rod 502. For example, the rod ends 530 may be snapped into the rod locks 532 of the lifter cover 304 to secure the filter rod 502 into the lifter cover 304.

The filter rod 502 may further define bristles 336 extending outwards from the two upper faces 528 of the filter rod 502. The bristles 336 may be of various forms and materials and may collectively define surfaces for the free flow of wash fluid 110 and the capture of particulate.

FIG. 19 illustrates an example sieve 504. In one example, the sieve 504 may be a 60-80 micron material. The sieve 504 may be overmolded with the lifter cover 304 to aid in the retention of particulate exiting the water outlet 520 that may not be fully captured by the bristles 336 of the filter rod 502.

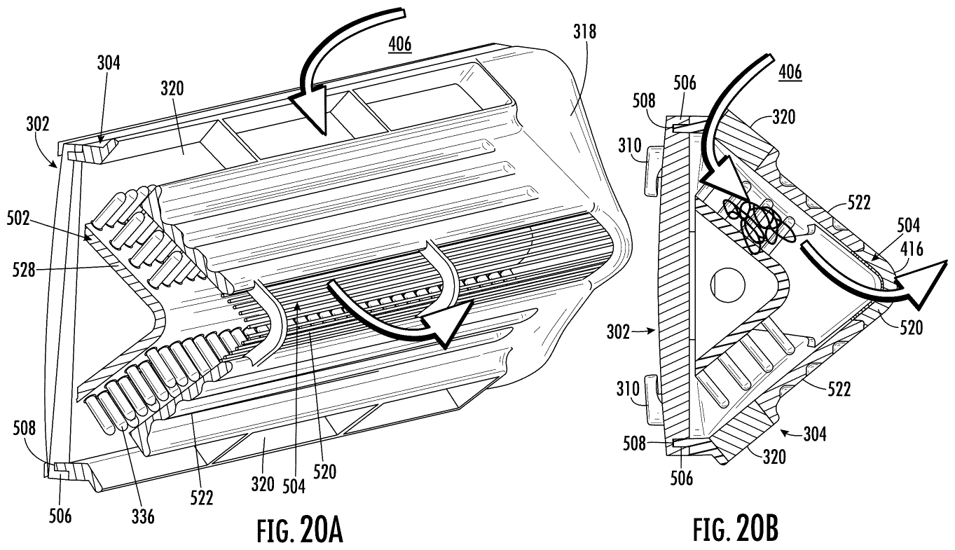

FIG. 20A illustrates an example cross-sectional perspective view of the assembled removable filter apparatus 200 of FIG. 15. FIG. 20B illustrates an example cross-sectional side view of the assembled removable filter apparatus 200 of FIG. 15. As shown in FIGS. 20A-B, during operation of the laundry treating appliance 100, wash fluid 110 in the drum 106 enters the through openings 638 of the removable filter apparatus 200, passes through the bristles 336 of the filter rod 502, and continues through the sieve 504 and out back into the drum 106. Thus pet hair and other particulates collect within the removable filter apparatuses 200 during the operation of the laundry treating appliance 100.

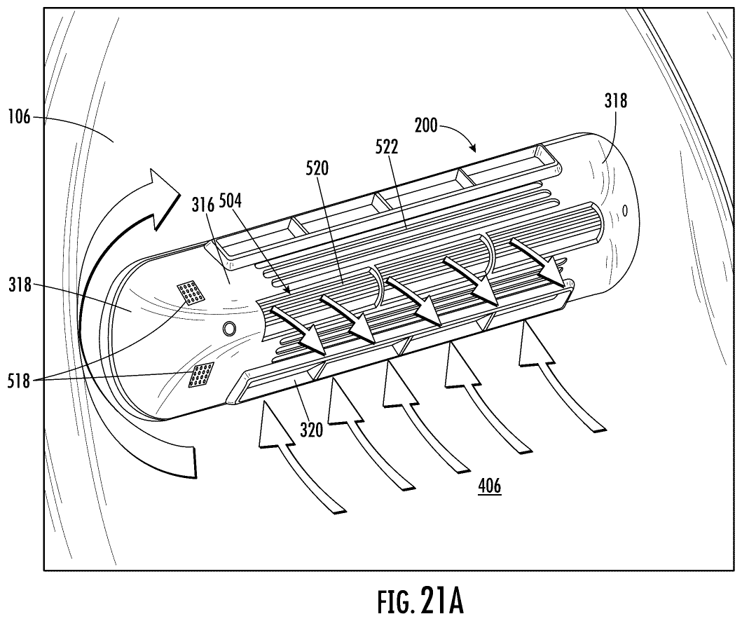

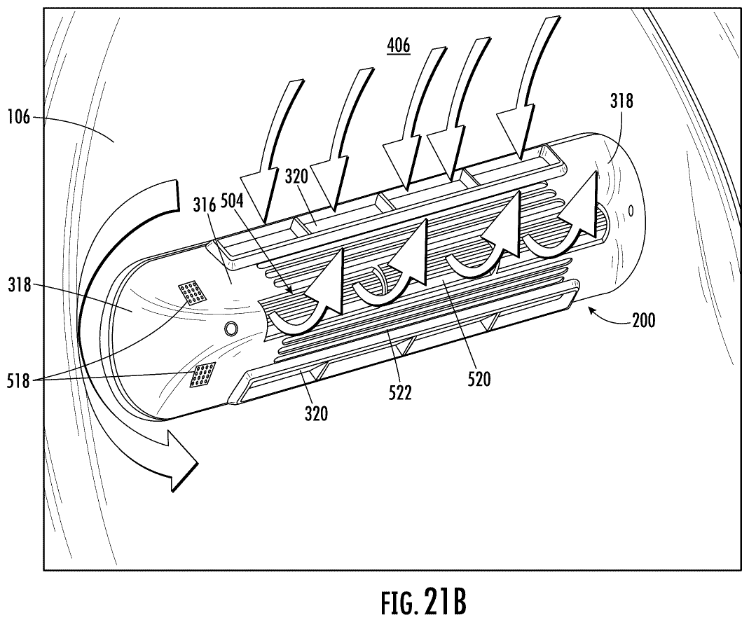

FIG. 21A illustrates an example perspective view of the operation of the assembled removable filter apparatuses 200 when the drum 106 is rotating in a clockwise direction. FIG. 21B illustrates an example perspective view of the operation of the assembled removable filter apparatuses 200 when the drum 106 is rotating in a counter-clockwise direction. As shown, during clockwise rotation, the wash fluid 110 enters through the through openings 638 of lower of the longitudinal walls 316. During the counter-clockwise rotation, the wash fluid 110 enters through the through openings 638 of upper of the longitudinal walls 316. In either case the wash fluid 110 exits through the sieve 504 at the apex 416 of the lifter cover 304.

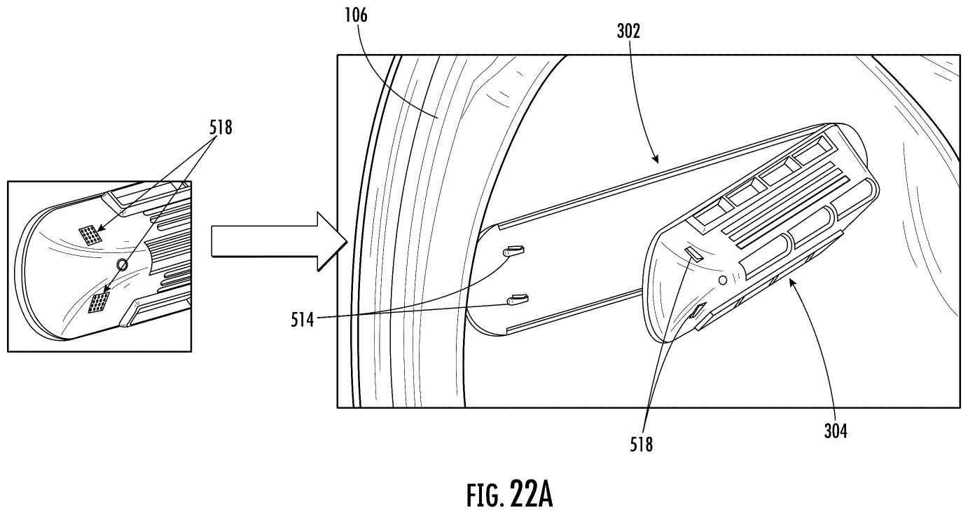

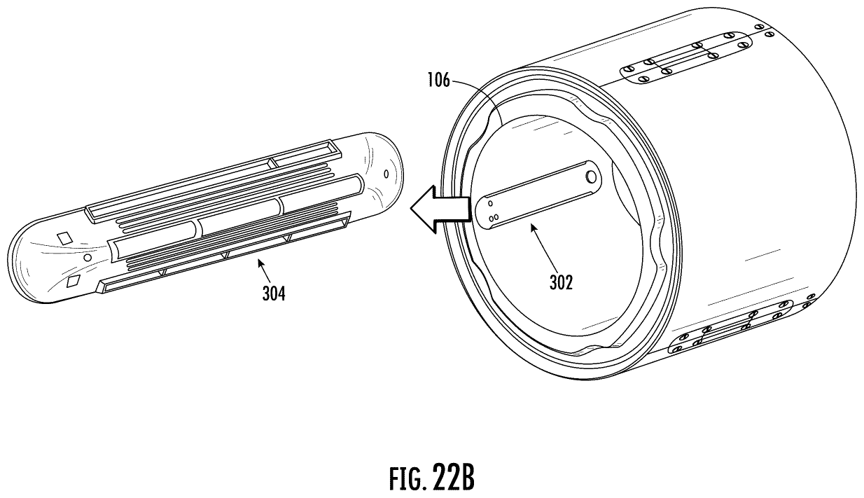

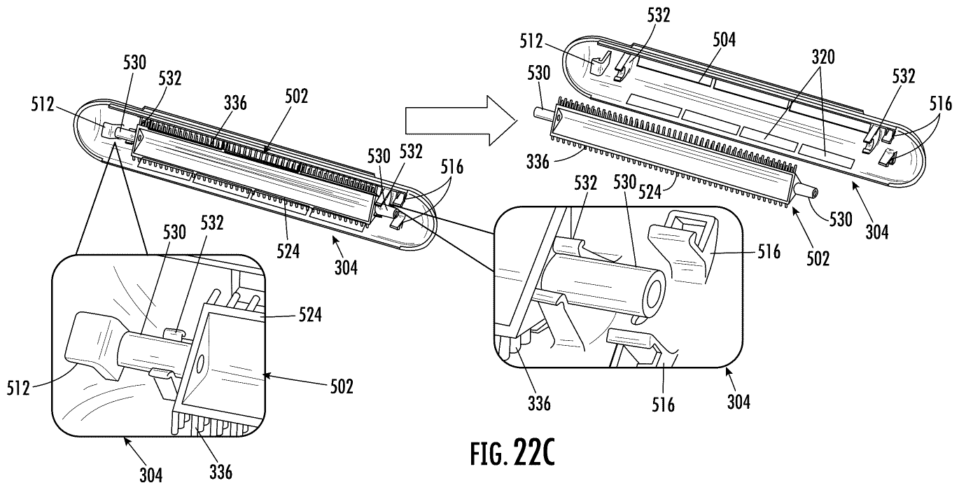

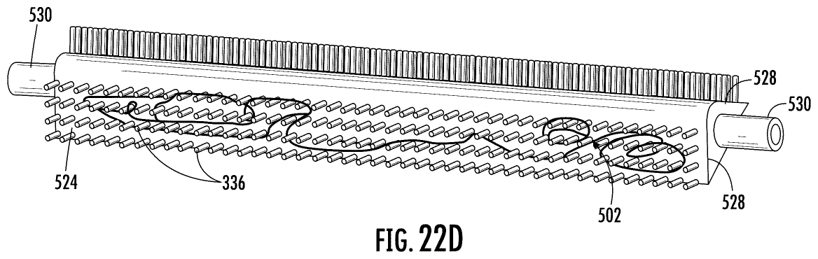

FIGS. 22A-22D collectively illustrate steps for the cleaning of the filter rod 502 of the removable filter apparatus 200. As shown in FIG. 22A, the lock release buttons 518 are pressed to unlatch the snap locks 516 of the lifter cover 304 from the snaps 514 of the lifter base 302. The lifter cover 304 may then be rotated open with the guide 512 of the lifter cover 304 maneuvering within the slide 510 of the lifter base 302. As shown in FIG. 22B, the lifter cover 304 is removed from the drum 106 of the laundry treating appliance 100 (not pictured).

As shown in FIG. 22C, the filter rod 502 is removed from the lifter cover 304. Here, the filter rods 502 of the filter rod 502 are unsnapped from the rod locks 532 of the lifter cover 304. This may be accomplished, for example by pulling the filter rod 502 downwards out of the lifter base 302. As shown in FIG. 22D, the filter rod 502 freed from the lifter cover 304 may be cleaned of any pet hair or other particulate. This may be accomplished in various ways, such as by running water over the filter rod 502, the operator pulling hair from the bristles 336 of the filter rod 502, etc.

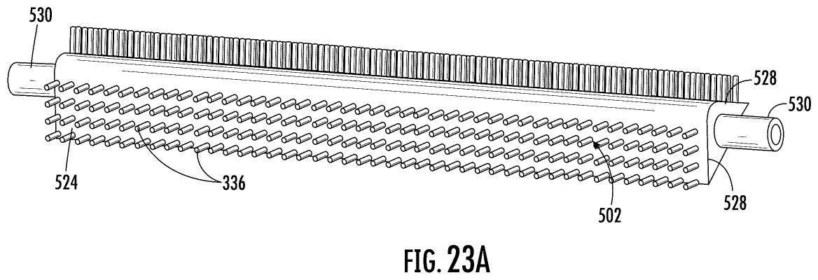

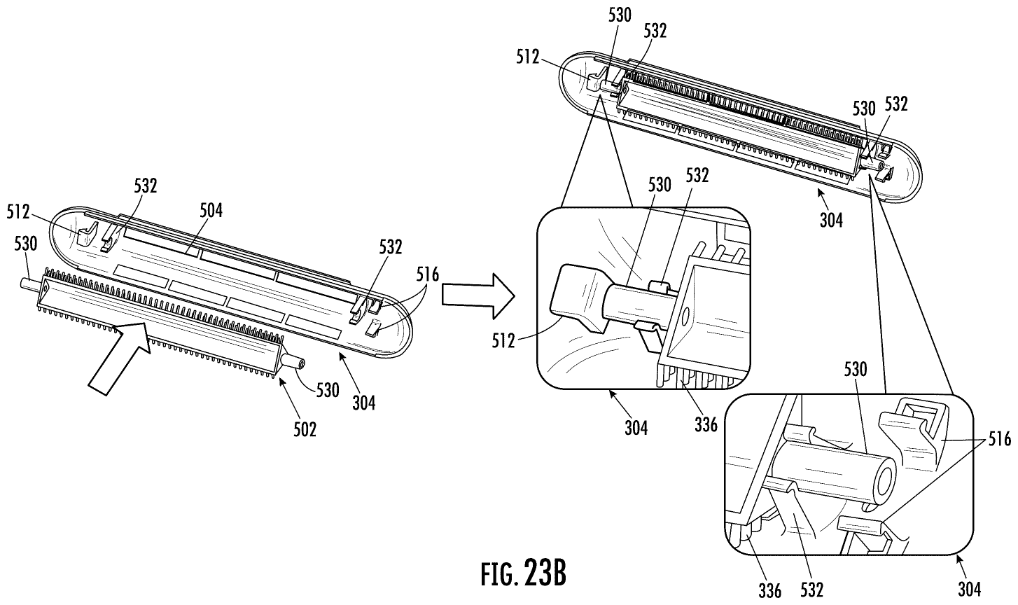

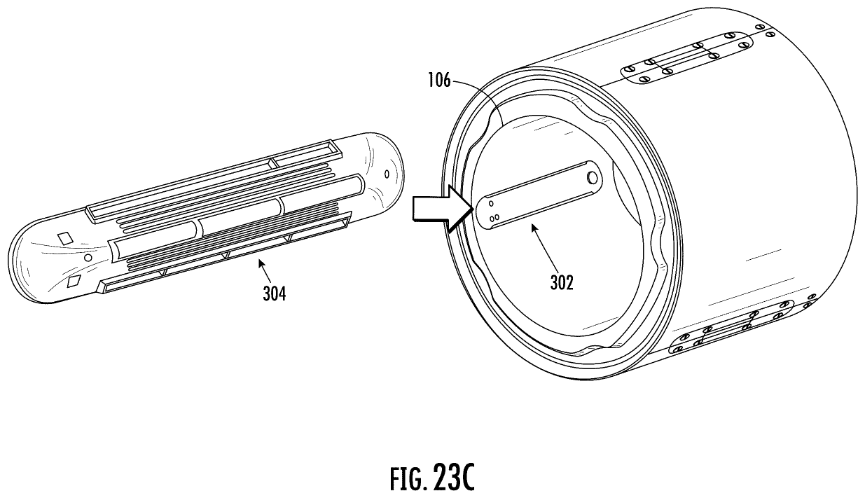

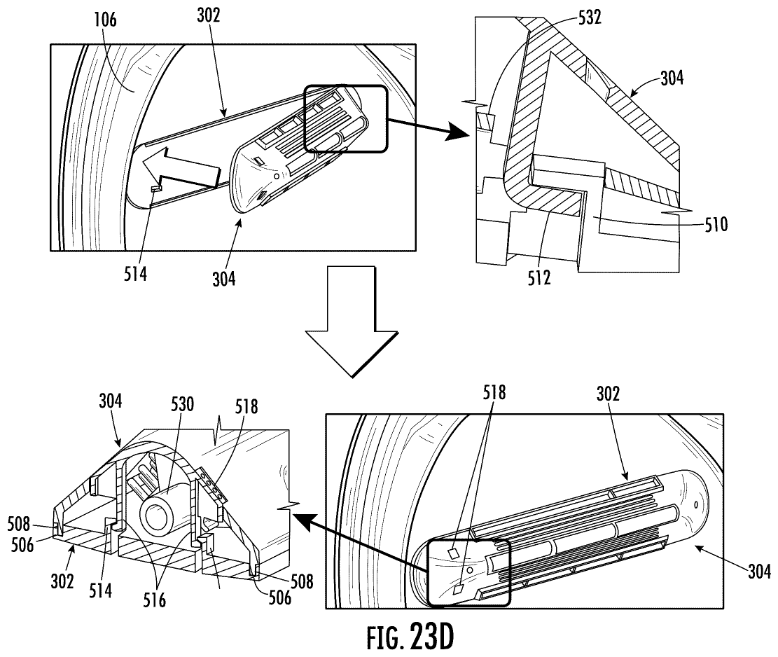

FIGS. 23A-23D collectively illustrate steps for the reassembly of the removable filter apparatus 200 for use. As shown in FIG. 23A, the cleaned filter rod 502 is provided for attachment. For example, the filter rod 502 may have been cleaned as shown in FIG. 22D. As shown in FIG. 23B, the filter rod 502 is snapped into the lifter cover 304. For example, the operator may press the rod ends 530 of the filter rod 502 into the rod locks 532 in the underside of the lifter cover 304.

As shown in FIG. 23C, the lifter cover 304 carrying the filter rod 502 is brought to the drum 106 of the laundry treating appliance 100. As shown in FIG. 23D, the lifter cover 304 is attached to the lifter base 302. For example, as shown in the upper portion of FIG. 23D, the guide 512 of the lifter cover 304 may be received into the slide 510 of the lifter base 302. Then, as shown in the lower portion of FIG. 23D, the front portion of the lifter cover 304 may be pressed into the lifter base 302, causing the snaps 514 of the lifter base 302 to be received into the snap locks 516 of the lifter cover 304.

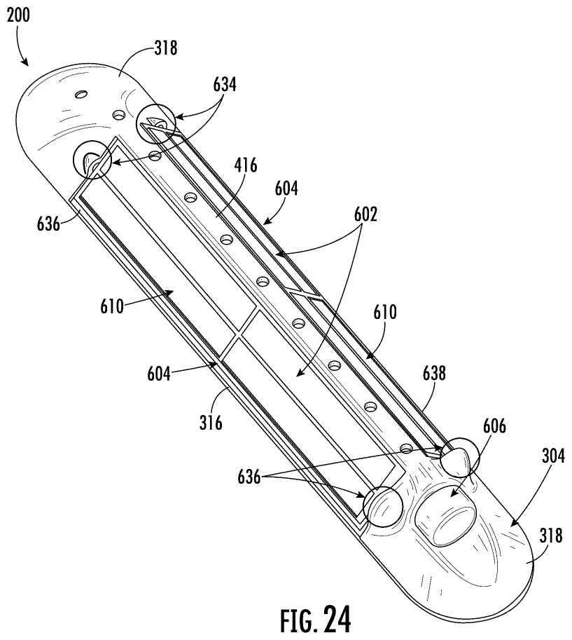

FIG. 24 illustrates an example perspective view of yet another alternative removable filter apparatus 200. As shown, the removable filter apparatus 200 includes a lifter cover 304, a turning flap assembly 602 including a pair of turning flaps 604, and a turning knob 606. The lifter cover 304 may be fixed to the drum 106 (e.g., with a lifter base 302 or directly) and may define a generally rectangular surface with rounded corners. The lifter cover 304 may define the exterior appearance of the removable filter apparatus 200, which as shown comprises two longitudinal walls 316 and two generally semicircular end caps 318 meeting at the apex 416, collectively defining a generally trapezoidal prism shape with rounded end caps 318. Each turning flap 604 may comprise a turning flap frame 608 and a filter strip 610. Each turning flap frame 608 may define a flat rectangular structure with a first face for holding a filter strip 610 and a flat opposite face without filter material. The filter strips 610 may be installed to the turning flap frames 608 for performance of a laundry cycle of the laundry treating appliance 100. Once the laundry treating appliance 100 has completed the cycle, the filter strips 610 may be removed and cleaned or disposed of.

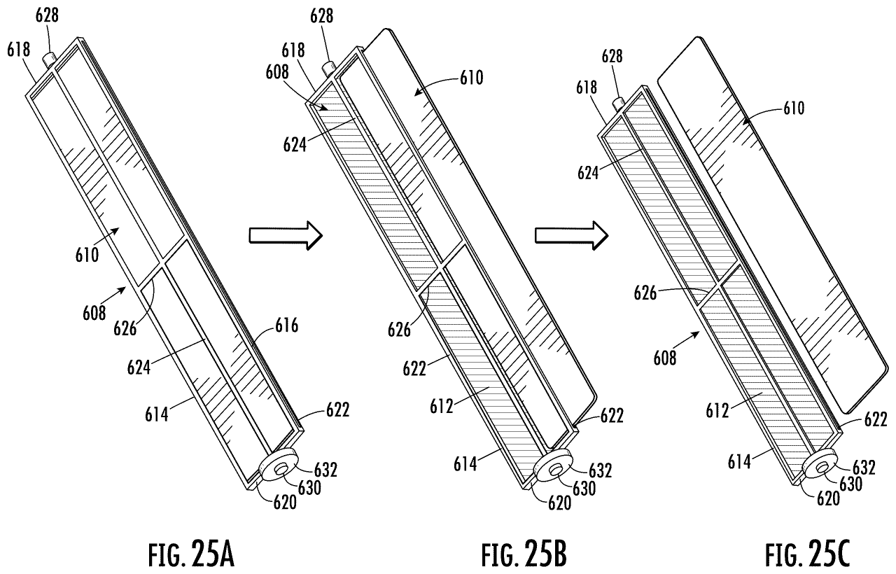

FIG. 25A illustrates an example perspective view of the removable filter strip 610 loaded into the turning flap 604. FIG. 25B illustrates an example perspective view of the removable filter strip 610 partially removed from the turning flap 604. FIG. 25C illustrates an example perspective view of the removable filter strip 610 completely removed from the turning flap 604.

Referring collectively to FIGS. 25A-C, the filter strip 610 may be a thin rectangular sheet of a material designed to capture pet hair or other particulates in the wash fluid 110. In one example, the filter strip 610 may be a positively charged material with an affinity for giving up electrons when brought in contact with other materials. As some non-limiting examples, the filter strip 610 may be composed of one or more of glass, nylon, wool, silk, aluminum, paper, etc. As hair in the wash fluid 110 may be naturally negatively charged, such detritus may be attracted to the positively charged filter strip 610 and become trapped thereon due to static electricity. Thus, the hair may be separated from the laundry articles being washed during the laundry treatment cycle. In other examples, a negatively charged filter strip 610 may be used, for picking up positively charged detritus in the wash fluid 110. In such a case, a material with an affinity for attracting electrons when brought in contact with other materials may be used, such as wood, nickel, copper, brass, polyester, polyurethane, vinyl, Teflon, etc.

The turning flap frame 608 may define a structure for holding the filter strip 610. As shown, the turning flap frame 608 may define a rectangular mat area 612 for supporting the back of the filter strip 610. The turning flap frame 608 may further define a frame around the rectangular mat area 612. As shown the turning flap frame 608 defines a lower frame edge 614, an upper frame edge 616, a rear frame edge 618, and a front frame edge 620. The upper frame edge 616 may define a through slot 622 through which the filter strip 610 may be slid into the turning flap frame 608. While not shown, one or more of the frame edges 614, 616, 618 may optionally define grooves aligned with the through slot 622 for receiving the periphery of the filter strip 610 to maintain the filter strip 610 within the turning flap frame 608.

A longitudinal cross brace 624 may extend parallel to the lower and upper frame edges 614, 616 of the outer frame at a midpoint, and a lateral cross brace 626 may extend parallel to the front and rear frame edges 618, 620 of the outer frame at a midpoint, the cross braces 624, 626 meeting at the center of the turning flap frame 608. These cross braces 624, 626 may be spaced away from the rectangular mat area 612, to allow the filter strip 610 to be slid between the cross braces 624, 626 and the rectangular mat area 612. Thus, the rectangular mat area 612, frame edges 614, 616, 618, and 620, and cross braces 624, 626 may collectively define a rectangular structure sized to receive and support the filter strip 610. While not shown, the back side of the rectangular mat area 612 may define a flat surface consistent with the exterior finish of the lifter cover 304.

A rear flap pivot pin 628 may be mounted to the center rear of the rear frame edge 618. Additionally, a front flap pivot pin 630 may be mounted to the center front of the front frame edge 620. A flap gear 632 may additionally be fixed to the front flap pivot pin 630, to provide for controlled rotation of the turning flap 604 as discussed in further detail below. As shown FIG. 24, the flap pivot pin 628 may be received into a corresponding pivot pin mount 634 in the rear of the lifter cover 304, while the front flap pivot pin 630 with the flap gear 632 may be received into a corresponding flap gear mount 636 in the front of the lifter cover 304. The lifter cover 304 may define openings 638 behind the turning flaps 604, providing clearance for the turning flaps 604 to rotate about an axis through the longitudinal center of the turning flaps 604 defined by the rear flap pivot pin 628 and front flap pivot pin 630.

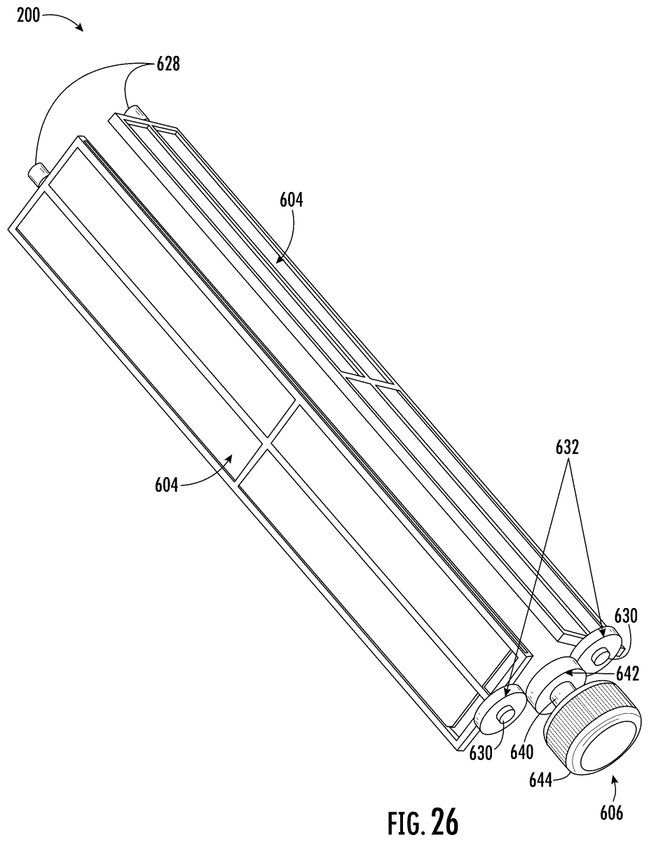

FIG. 26 illustrates an example perspective view of the gearing that provides for rotation of the turning flaps 604 of turning flap assembly 602. For sake of explanation, the turning flap assemblies 602 and the turning knob 606 are shown without the lifter cover 304. However, in practice, these components would be mounted to the lifter cover 304 as shown in FIGS. 24 and 27-29.

With continuing reference to FIG. 26, the turning knob 606 may define an axle 640 to which a knob gear 642 may be fixed on an interior end and to which a knob end 644 may be fixed on the exterior end. The axle 640 may accordingly transmit rotation of the knob end 644 received from an operator to the knob gear 642. The knob gear 642 may mesh with the flap gears 632 of each of the two turning flaps 604 of the turning flap assembly 602. Thus, rotation of the knob end 644 may correspondingly drive the rotation of each of the turning flaps 604 of the turning flap assembly 602.

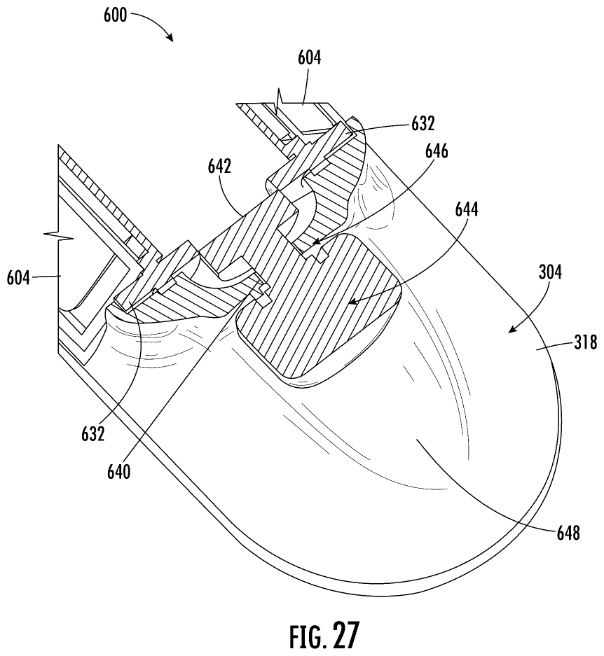

FIG. 27 illustrates an example section perspective view showing details of the turning knob 606 of the lifter cover 304. As shown, the axle 640 of the turning knob 606 passes through a knob mount 646 defined in the longitudinal direction through the center of the exterior end cap 318 of the lifter cover 304. The knob gear 642 may accordingly be mounted inside the lifter cover 304 while the knob end 644 is mounted outside the lifter cover 304. Additionally the exterior end cap 318 may define a knob recess 648 to provide clearance for rotation of the knob end 644 by the operator, while also keeping the turning knob 606 safe from catching on laundry items during operation of the laundry treating appliance 100.

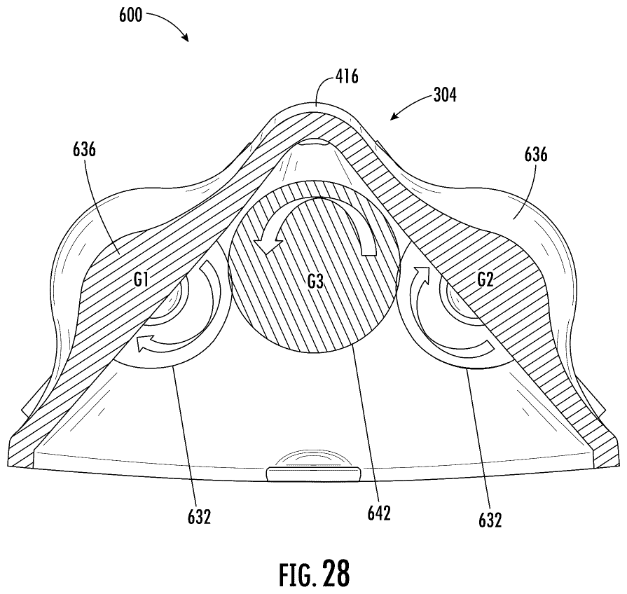

FIG. 28 illustrates an example section side view showing details of the operation of the gears of the lifter cover 304. As shown, turning of the knob end 644 causes the rotation of each of the turning flaps 604 of the turning flap assembly 602. Notably, each of the turning flaps 604 turns in the same direction, which is the opposite direction of the rotation of the knob end 644. Additionally, as the flap gears 632 are of the same size, the amount of rotation of each of the turning flaps 604 may be the same amount of rotation, thereby keeping the turning flaps 604 aligned in position.

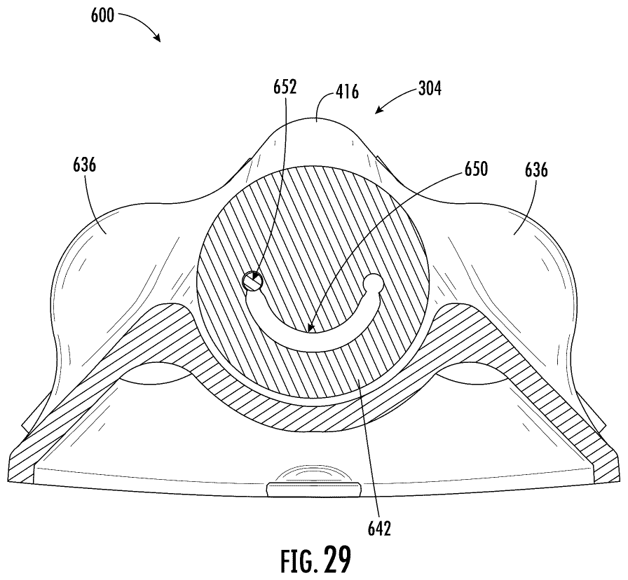

FIG. 29 illustrates an example section side view showing details of the attachment of the turning flaps 604 to the gears. As shown, in some examples the turning knob 606 may define a circumferential groove 650 within a portion of the circumference of the turning knob 606. Each of the turning flaps 604 may, in turn, define limit pins 652 sized to mate with the circumferential groove 650. As the limit pins 652 may only travel until the ends of the circumferential groove 650, the range of rotation of the turning flaps 604 may be restricted to a fixed amount of rotary motion.

In one example, the fixed amount of rotation may be 180 degrees, such that the turning flaps 604 of the turning flap assembly 602 may be rotated from the side holding the filter strip 610 to the opposite side without the filter strip 610. This may be useful, for example, to allow the operator to choose between the particulate trapping side or the flat surface, considering the type of laundry being washed. For example, the flat side may be preferred for delicates that should not come into contact with the surface of the filter strip 610.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A removable filter apparatus for a laundry treating appliance, comprising:
a lifter cover, defining a generally rectangular prism shape with an open rectangular bottom, the lifter cover being slidably attachable along the open rectangular bottom to a lifter base of an inner circumferential surface of a drum of the laundry treating appliance, the lifter cover defining through openings to allow for free flow of water therethrough;
a filter element defining a rectangular body sized to fit within the lifter cover and including bristles extending from the rectangular body into the water flow to capture particulate within the water flow, the filter element being selectively attachable to the lifter base; and
a cleaning comb hingedly attached to the lifter cover by a snap-on hinge assembly, operable to be selectively rotatably lifted through the filter element to clean the bristles of the filter element.

2. The removable filter apparatus of claim 1, wherein the lifter base defines a plurality of engaging hooks, and the lifter cover defines a corresponding plurality of internal projections along its length, the engaging hooks being sized and positioned to receive respective ones of the internal projections of the lifter cover when the lifter cover is slid onto the lifter base.

3. The removable filter apparatus of claim 2, wherein the lifter base further defines guide rails extending outward along at least a portion of the length of the lifter base, allowing the projections to slide along the guide rails into the engaging hooks, thereby securing the lifter cover to the lifter base.

4. The removable filter apparatus of claim 3, wherein the lifter cover defines a lock opening through the lifter cover, sized to receive a snap button of the lifter base, the snap button being supported by a flexible leg extending upwards from the lifter base, such that as the lifter cover is slid onto the lifter base, the snap button rides an inner surface of the lifter cover, causing the flexible leg to bend downwards until the snap button reaches the lock opening to latch into place into the lock opening.

5. The removable filter apparatus of claim 4, wherein the snap button is pressable to free the snap button from the lock opening, allowing the lifter cover to be slid off the lifter base.

6. The removable filter apparatus of claim 1, wherein the filter element defines through holes to retain the filter element to latching posts extending upwards from an upper surface of the lifter base.

7. The removable filter apparatus of claim 1, wherein the bristles are arranged into an array of spaced apart rows and columns of bristle elements.

8. The removable filter apparatus of claim 7, wherein the lifter cover is contoured to vary in height with respect to the lifter base, and the bristles correspondingly vary in height to follow the contour of the inner surface of the lifter cover.

9. The removable filter apparatus of claim 7, wherein the cleaning comb comprises a generally flat rectangular base defining an array of pass throughs corresponding to the bristles as arranged, allowing the cleaning comb to fit between the rows and columns of the array of bristles of the filter element.

10. The removable filter apparatus of claim 9, wherein the cleaning comb defines an end pivotably attached to a corresponding end of the filter element by the snap-on hinge assembly, such that the cleaning comb is rotatably positionable flat against the filter element during operation of the laundry treating appliance and pivotable through the bristles of the filter element for cleaning of the filter element.

11. The removable filter apparatus of claim 7, wherein the filter element comprises a hinge snap of the snap-on hinge assembly defining a semi-circular hinge channel, and the cleaning comb defines a pivot pin of the snap-on hinge assembly, parallel to and spaced away from the rectangular body of the filter element, such that the hinge snap is attachable to the pivot pin to allow the filter element to rotate freely about the pivot pin.

12. The removable filter apparatus of claim 1, wherein the lifter cover further comprises an undulating upper surface to promote water flow turbulence and improved particulate capture within the filter element.

13. The removable filter apparatus of claim 1, wherein the through openings in the lifter cover are defined by longitudinal sides of the lifter cover in a spaced-apart pattern to prevent laundry articles from entering the lifter cover while allowing the free flow of water during both clockwise and counter-clockwise rotation of the drum.

14. A laundry treating appliance having a removable filter apparatus, comprising:
a lifter base attached to an inner circumferential surface of a drum of the laundry treating appliance;
a lifter cover, defining a generally rectangular prism shape with an open rectangular bottom, the lifter cover being slidably attachable along the open rectangular bottom to the lifter base, the lifter cover defining through openings to allow for passage of a water flow;
a filter element defining a rectangular body sized to fit within the lifter cover and including bristles extending from the rectangular body into the water flow to capture particulate within the water flow, the filter element being selectively attachable to the lifter base; and
a cleaning comb hingedly attached to the lifter cover by a snap-on hinge assembly, operable to be rotatably lifted through the filter element to clean the bristles of the filter element.

15. The laundry treating appliance of claim 14, wherein the lifter base defines guide rails extending outward along at least a portion of the length of the lifter base and a plurality of engaging hooks, and the lifter cover defines a corresponding plurality of internal projections along its length, the engaging hooks being sized and positioned to receive respective ones of the internal projections of the lifter cover, allowing the projections to slide along the guide rails into the engaging hooks, thereby securing the lifter cover to the lifter base as the lifter cover is slid onto the lifter base.

16. The laundry treating appliance of claim 15, wherein the lifter cover defines a lock opening through the lifter cover, sized to receive a snap button of the lifter base, the snap button being supported by a flexible leg extending upwards from the lifter base,
such that as the lifter cover is slid onto the lifter base, the snap button rides an inner surface of the lifter cover, causing the flexible leg to bend downwards until the snap button reaches the lock opening to latch into place into the lock opening, and
such that the snap button is pressable to free the snap button from the lock opening, allowing the lifter cover to be slid off the lifter base.

17. The removable filter apparatus of claim 16, wherein the lifter base defines a set of latching posts to fit into corresponding through holes defined through the filter element, each of the latching posts may extending upwards from an upper surface of the lifter base and defining a catch at its upper end extending towards the flexible leg, the catches being sized to fit through the through holes to retain the filter element into place between the catches and the lifter base.

18. The laundry treating appliance of claim 15, wherein the bristles are arranged into an array of spaced apart rows and columns of bristle elements, and the cleaning comb comprises a generally flat rectangular base defining an array of pass throughs corresponding to the bristles as arranged, allowing the cleaning comb to fit between the rows and columns of the array of bristles of the filter element.

19. The laundry treating appliance of claim 15, wherein the filter element comprises a hinge snap of the snap-on hinge assembly defining a semi-circular hinge channel, and the cleaning comb defines a pivot pin of the snap-on hinge assembly, parallel to and spaced away from the rectangular body of the filter element, such that the hinge snap is attachable to the pivot pin to allow the filter element to rotate freely about the pivot pin, such that the cleaning comb is rotatably positionable flat against the filter element during operation of the laundry treating appliance and pivotable through the bristles of the filter element for cleaning of the filter element.

20. The laundry treating appliance of claim 15. wherein the lifter cover is contoured to vary in height with respect to the lifter base, and the bristles correspondingly vary in height to follow the contour of the inner surface of the lifter cover, allowing the bristles to extend throughout the lifter cover.
